(19) United States
(12) Patent Application Publication
(10) Pub. No.: US 2025/0373419 A1
(43) Pub. Date: Dec. 4, 2025

(54) KEYED HASH FUNCTION WITH SOMEWHERE STATISTICAL CORRELATION INTRACTABILITY

(71) Applicant: NTT Research, Inc., Sunnyvale, CA (US)

(72) Inventors: Justin Holmgren, Sunnyvale, CA (US); Brent Waters, Austin, TX (US)

(73) Assignee: NTT Research, Inc., Sunnyvale, CA (US)

(21) Appl. No.: 19/223,016

(22) Filed: May 29, 2025

Related U.S. Application Data
(60) Provisional application No. 63/652,967, filed on May 29, 2024.

(51) Int. Cl. H04L 9/08; G06F 21/14; H04L 9/00; H04L 9/32

(52) U.S. Cl. CPC H04L 9/0861; G06F 21/14; H04L 9/008; H04L 9/3242

(57) ABSTRACT

The present disclosure provides a method for generating and evaluating a keyed hash function, the method comprising: receiving one or more integer parameters indicating a target input length n and a target output length m for the keyed hash function; receiving a target circuit-size parameter S, wherein the circuit-size parameter S is correlated to a security level of the keyed hash function; generating a hash key, the generated hash key comprising a ciphertext ct of a secret-key fully homomorphic encryption (FHE) scheme, wherein the ciphertext ct is generated by generating a secret key sk for a secret-key FHE scheme, generating the ciphertext ct as an encryption to sk of a message comprising sk concatenated with a string of S zero bits, and storing the ciphertext ct as the generated hash key; and computing a hash output based on the generated hash key ct and an input x.

### CROSS-REFERENCE TO RELATED APPLICATION

This application claims the benefit of U.S. Provisional Application Ser. No. 63/652,967 filed May 29, 2024, the content of which is incorporated by reference herein in its entirety for all purposes.

### FIELD OF THE INVENTION

The present disclosure relates to cryptographic hash functions, and more particularly to a keyed hash function that achieves somewhere statistical correlation intractability for efficiently enumerable relations using fully homomorphic encryption.

### BACKGROUND OF THE INVENTION

Cryptographic hash functions serve as fundamental building blocks in modern information security systems, providing essential mechanisms for data integrity verification, digital signatures, and authentication protocols. These mathematical functions transform input data of arbitrary length into fixed-size output values, creating unique digital fingerprints that enable secure communication and data protection across diverse computing environments.

Traditional hash functions operate through deterministic algorithms that produce consistent outputs for identical inputs while exhibiting the avalanche effect, where minor input modifications result in dramatically different hash values. The security properties of conventional hash functions include preimage resistance, second preimage resistance, and collision resistance, which collectively ensure that adversaries cannot feasibly reverse-engineer original data from hash outputs or generate malicious inputs that produce identical hash values.

Keyed hash functions extend these foundational concepts by incorporating secret cryptographic keys into the hashing process, thereby introducing additional layers of security through key-dependent randomization. These functions combine input messages with secret keys to generate message authentication codes that provide both data integrity and authenticity verification. The integration of secret keys prevents unauthorized parties from generating valid hash outputs even when they possess knowledge of the underlying hash algorithm and input data.

The theoretical framework of correlation intractability represents a sophisticated security property wherein hash functions resist attacks that exploit statistical relationships between inputs and outputs. This property ensures computational infeasibility in finding input-output pairs that satisfy specific mathematical relations, thereby strengthening the overall security posture of cryptographic systems. Correlation intractability provides protection against advanced cryptanalytic techniques that attempt to exploit patterns or correlations within hash function behavior.

Somewhere statistical correlation intractability constitutes an enhanced security paradigm that extends traditional correlation intractability concepts to encompass efficiently enumerable relations. This advanced property requires that hash functions maintain security against adversaries who can enumerate potential input-output relationships through computational circuits of bounded complexity. The statistical component of this property introduces probabilistic guarantees that strengthen security assurances beyond deterministic bounds.

Fully homomorphic encryption represents a transformative cryptographic capability that enables arbitrary computations on encrypted data without requiring decryption operations. These encryption schemes support both addition and multiplication operations on ciphertexts, allowing complex mathematical functions to be evaluated while preserving data confidentiality. The integration of fully homomorphic encryption with hash function construction opens new possibilities for privacy-preserving cryptographic protocols and secure computation frameworks.

Indistinguishability obfuscation provides theoretical foundations for program obfuscation, enabling the transformation of computer programs into functionally equivalent but computationally indistinguishable variants. This cryptographic primitive allows the hiding of program implementation details while preserving computational functionality, creating opportunities for secure software distribution and intellectual property protection. The combination of indistinguishability obfuscation with hash function design enables the construction of cryptographic primitives with enhanced security properties.

Circuit-based security analysis examines cryptographic constructions through the lens of computational complexity theory, evaluating security properties relative to the size and structure of adversarial circuits. This analytical framework provides precise characterizations of security levels by relating cryptographic strength to the computational resources required for successful attacks. Circuit complexity parameters serve as fundamental metrics for quantifying the security guarantees provided by cryptographic constructions.

Enumerable relations in cryptographic contexts represent mathematical relationships that can be efficiently computed or listed through algorithmic processes. These relations capture various forms of input-output dependencies that adversaries might attempt to exploit in cryptographic attacks. The efficient enumerability of relations provides a frame-work for analyzing the computational resources required to identify exploitable patterns within cryptographic systems.

The construction of hash families with advanced security properties requires sophisticated mathematical techniques that combine multiple cryptographic primitives and security rity assumptions. These constructions must balance theoretical security guarantees with practical implementation considerations, ensuring that resulting hash functions provide robust protection while maintaining computational efficiency. The development of such constructions represents a significant challenge in modern cryptographic research.

Existing cryptographic literature demonstrates various approaches to constructing correlation intractable hash functions, typically relying on strong computational assumptions such as the hardness of specific mathematical problems. However, these constructions often provide limited security guarantees or require assumptions that may not hold in practical deployment scenarios. The gap between theoretical security properties and practical implementation requirements continues to present challenges for cryptographic system designers.

Current hash function constructions exhibit limitations in achieving somewhere statistical correlation intractability for efficiently enumerable relations, particularly when considering the computational complexity of potential adversarial attacks. The absence of practical constructions that provide these enhanced security properties restricts the development of advanced cryptographic protocols that require strong correlation intractability guarantees. These limitations become particularly pronounced in applications involving program obfuscation, secure multi-party computation, and privacy-preserving data processing.

The integration of fully homomorphic encryption with hash function design presents both opportunities and challenges for achieving enhanced security properties. While homomorphic encryption enables computation on encrypted data, the construction of hash functions that leverage these capabilities while maintaining correlation intractability requires careful analysis of the interaction between encryption operations and hash function security properties. The complexity of these interactions often results in constructions that are either theoretically sound but practically inefficient, or practically viable but with limited security guarantees.

Contemporary cryptographic research has identified the need for hash functions that can resist sophisticated attacks while supporting advanced applications such as obfuscation-friendly cryptography and secure computation protocols. The development of such hash functions requires novel construction techniques that combine multiple cryptographic primitives in ways that preserve individual security properties while achieving enhanced collective security guarantees. The mathematical complexity of these constructions often presents significant barriers to practical implementation and deployment.

The current state of cryptographic hash function research reveals significant gaps between theoretical security requirements and practical construction capabilities, particularly in the domain of somewhere statistical correlation intractability for efficiently enumerable relations. These limitations constrain the development of advanced cryptographic systems and highlight the need for innovative approaches that can bridge the gap between theoretical security properties and practical implementation requirements.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for generating and evaluating a keyed hash function is provided. The method comprises receiving one or more integer parameters indicating a target input length n and a target output length m for the keyed hash function. The method comprises receiving a target circuit-size parameter S, wherein the circuit-size parameter S is correlated to a security level of the keyed hash function. The method comprises generating a hash key, the generated hash key comprising a ciphertext ct of a secret-key fully homomorphic encryption (FHE) scheme, wherein the ciphertext ct is generated by generating a secret key sk for a secret-key FHE scheme, generating the ciphertext ct as an encryption to sk of a message m, the message m comprising sk concatenated with a string of S zero bits, and storing the ciphertext ct as the generated hash key. The method comprises computing a hash output based on the generated hash key ct and an input x, by generating an encryption ŷ of a string z by constructing a representation Cₓ of the boolean circuit that on input of a pair (sk, E), wherein E is a representation of a boolean circuit and computes an output by evaluating E on x to obtain a list (ŷ₁, . . . , [symbol] ), executing an FHE decryption procedure of the FHE scheme on each ŷᵢ, using secret key sk, to generate a corresponding m-bit string yᵢ, and outputting a lexicographically first m-bit string z which is not one of y₁, . . . , [symbol] . The method comprises homomorphically evaluating Cₓ on the hash key ct and storing the result as ŷ. The method comprises appending zero bits to the homomorphically evaluated ciphertext ŷ such that it has length m, and storing the result as the output of the keyed hash function.

According to other aspects of the present disclosure, the method may include one or more of the following features. The circuit-size parameter S may be selected such that a larger value of S corresponds to a hash function whose mapping of inputs to outputs is more pseudorandom. The circuit-size parameter S may specify a level of circuit complexity such that the constructed keyed hash function should satisfy somewhere-statistical correlation intractability with respect to all relations whose circuit complexity is at most S.

The foregoing method is equally applicable to a system comprising one or more processors configured to perform the method steps, and to a computer-readable medium storing instructions that, when executed by one or more processors, cause the processors to perform the method steps.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a flowchart for a method for generating and evaluating a keyed hash function, according to aspects of the present disclosure.

FIG. 2 illustrates a flowchart for a method for generating and evaluating a keyed hash function using fully homomorphic encryption, according to aspects of the present disclosure.

FIG. 3 illustrates a block diagram of a computer system, according to aspects of the present disclosure.

FIG. 4 illustrates a flowchart for a keyed hash function system, according to aspects of the present disclosure.

FIG. 5 illustrates a block diagram of a cryptographic hash system, according to aspects of the present disclosure.

FIG. 6 illustrates a block diagram of the computer system of FIG. 3, according to aspects of the present disclosure.

FIG. 7 illustrates a block diagram of a client computing architecture, according to aspects of the present disclosure.

FIG. 8 illustrates a block diagram of a server-client network architecture, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The present disclosure relates to cryptographic systems and methods, and more particularly, to a keyed hash function that leverages the principles of homomorphic encryption and indistinguishability obfuscation. In some aspects, the disclosure provides a method for generating and evaluating a keyed hash function that offers enhanced security properties, such as somewhere statistical correlation intractability (SS-CI) for efficiently enumerable relations. This property ensures that it is computationally infeasible to find correlated input-output pairs, making the hash function appear random and thus secure against a wide range of attacks.

In some cases, the keyed hash function may be constructed using a secret-key fully homomorphic encryption (FHE) scheme. FHE allows computations to be performed on encrypted data without needing to decrypt it first, which is a powerful tool for privacy-preserving computations. The use of FHE in the construction of the hash function allows the hash function to be evaluated obliviously on encrypted inputs, enhancing the security of the hash function.

In other aspects, the disclosure provides a method for handling various types of input messages, including plaintext, pre-hashed, binary, concatenated, structured, time-stamped, and keyed strings. Each type of input message has its specific use cases and security implications, making the keyed hash function a versatile and powerful tool in the cryptographic toolkit.

Furthermore, the disclosure provides a method for managing the secret keys used in the keyed hash function. This includes generating, storing, and distributing the keys in a secure manner. The secret keys play a central role in the keyed hash function, influencing the hash output and ensuring message integrity and authenticity.

In yet other aspects, the disclosure provides a method for handling the output of the keyed hash function. This includes computing the hash output, appending zero bits to the homomorphically evaluated ciphertext to ensure it has a specific length, and storing the result as the output of the keyed hash function.

Overall, the present disclosure provides a comprehensive framework for constructing and using a keyed hash function with enhanced security properties. This keyed hash function can be used in a wide range of applications, including but not limited to, public-key encryption schemes, secure hash family constructions, homomorphic encryption, indistinguishability obfuscation, coding theory applications, and obfuscation-friendly crypto-graphic systems.

### 1 Preliminaries

Notation We write f:X [symbol] Y to denote a probabilistic function that on input x∈X, uses randomness to sample a value in Y. We use p.p.t. as an abbreviation for “probabilistic polynomial time”.

### Fully Homomorphic Encryption

Definition 1 (Fully Homomorphic Encryption). A (secret-key) fully homomorphic encryption (FHE) scheme for a class { [symbol] λ} [symbol] of circuits is a triple of polynomial-time algorithms (Enc, Dec, Eval), where Enc is probabilistic, such that:
(Perfect Evaluation Correctness) For all λ, n∈ [symbol] , all circuits C∈ [symbol] _{λ} with n inputs, and all x∈{0, 1}ⁿ, when computing

$$s k ← {\{ 0 , 1 \}}^{λ} \qquad ( 1 )$$

$$c {t}_{x} ← Enc ( sk , x )$$

$$c {t}_{y} := Eval ( C , {ct}_{x} )$$

$$y := Dec ( sk , {ct}_{y} )$$

it holds with probability 1 that y=C(x).
(Compactness) There exists a polynomially bounded function B: [symbol] → [symbol] such that for all λ, n, m∈ [symbol] , all circuits C∈ [symbol] _{λ} with n inputs and m outputs, and all strings x∈{0, 1}ⁿ, the ciphertext ct_{y} sampled in Eq. (1) has length m·B(λ).

The notion of FHE is due to Rivest, Adleman, and Dertouzos, and the first candidate construction (for all circuits of any fixed polynomial size) is due to Gentry based on ideal lattices. Later, Brakerski and Vaikuntanathan constructed FHE based only on the hardness of learning with errors (LWE), which is a more standard cryptographic assumption with a host of desirable properties.

One of our hash family constructions will rely on FHE with an additional circular security property.

Definition 2 (Circular Security). We say that an FHE scheme as in Definition 1 is circular secure if for any polynomial-length message ensembles

$${\{ {m}_{λ}^{( 0 )} ∈ {\{ 0 , 1 \}}^{{ℓ}_{λ}} \}}_{λ ∈ ℕ} and$$

$${\{ {m}_{λ}^{( 1 )} ∈ {\{ 0 , 1 \}}^{{ℓ}_{λ}} \}}_{λ ∈ ℕ} ,$$

we have

$$\{ Enc ( sk , sk ‖ {m}_{λ}^{( 0 )} ) \vert sk ← {\{ 0 , 1 \}}^{λ} {\approx }_{c} \{ E n c ( sk , sk ‖ {m}_{λ}^{( 1 )} ) \vert sk ← {\{ 0 , 1 \}}^{λ} \} .$$

It is not known how to construct circular-secure FHE based on the LWE assumption, but natural constructions are conjectured to be circular secure.

### 1.1 Circuit Obfuscation

Definition 3 (Circuit Equivalence). Let C₀ and C₁ be circuits with n input bits. We say that C₀ and C₁ are functionally equivalent (denoted C₀≡C₁) if for all x∈{0, 1}ⁿ, C₀(x)=C₁(x).

Definition 4 (Indistinguishability Obfuscation). An indistinguishability obfuscator is a p.p.t. algorithm i [symbol] :{0, 1}* [symbol] {0, 1}* such that:
Correctness If C is any boolean circuit, then every \tilde{C} in the support of i [symbol] (C) is a circuit that is functionally equivalent to C.
Security If

$${\{ {C}_{λ}^{0} \}}_{λ ∈ ℕ} and {\{ {C}_{λ}^{1} \}}_{λ ∈ ℕ}$$

are ensembles of circuits with

$$\vert {C}_{λ}^{0} \vert = \vert {C}_{λ}^{1} \vert = {λ}^{Θ ( 1 )} and {C}_{λ}^{0} ≡ {C}_{λ}^{1} ,$$

then

$${\{ i 𝒪 ( {C}_{λ}^{0} ) \}}_{λ} {\approx }_{c} {\{ i 𝒪 ( {C}_{λ}^{1} ) \}}_{λ} .$$

Applications of indistinguishability obfuscation generally rely on the simple fact that given any circuit, one can efficiently find a functionally equivalent circuit of any polynomially larger size.

Fact 1 (Padding) There is a polynomial-time algorithm that takes as input a circuit C and an integer p≥|C|, and outputs a circuit C′ satisfying C≡C′ and |C′|=p. We denote this circuit by Padₚ(C).

### 2 Somewhere Statistical Correlation Intractability

In this section we construct hash families that are somewhere statistically correlation intractable (SS-CI) for efficiently enumerable relations. Previously SS-CI hash families were known only for efficiently computable functions.

Definition 5 (Enumerable Relations). We say that a relation R⊆X×Y is (S, [symbol] )-enumerable if there is a size-S circuit E that on input x∈X, outputs (y₁, . . . , [symbol] )∈ [symbol] such that for all y∈Y, if (x, y)∈R then y∈{y₁, . . . , [symbol] }. In increasing levels of specificity, we can say that E is an enumerator, an l-enumerator, or an (S, l)-enumerator for R.

We say that R is size-S enumerable if it is (S, ∞)-enumerable (or equivalently, (S, S)-enumerable), and we say that R is [symbol] -enumerable if it is (∞, [symbol] )-enumerable.

Definition 6. We say that a function h: X→Y perfectly avoids a binary relation R if for all x∈X, h(x)∉R(x). We say that a hash family ensemble [symbol] ={ [symbol] _{λ}} [symbol] statistically avoids a relation ensemble R={R_{λ}} [symbol] if when sampling H← [symbol] _{λ}, it holds with all but λ^{-ω(1)} probability that H perfectly avoids R_{λ}.

Definition 7 (Somewhere Statistical Correlation Intractability). Let R={R_{λ}} [symbol] be a binary relation ensemble. An hash family ensemble [symbol] ={ [symbol] _{λ}} [symbol] is said to be somewhere statistically correlation intractable (SS-CI) for R if there exists a computationally indistinguishable hash family ensemble [symbol] ={ [symbol] _{λ}} [symbol] that statistically avoids R. We say that such a family [symbol] is an R-avoiding mode of [symbol] .

### 2.1 Boosting SS-CI: From Functions to Enumerable Relations

Our first construction relies on indistinguishability obfuscation (IO), and as such is inherently a private-coin construction. The computational assumptions besides IO are minimal: we start with any SS-CI hash family for polynomial-size computable functions, and we boost this to an SS-CI hash family for polynomial-size enumerable relations, which is a strictly larger class.

Construction 2 For any integers p, n, m, any hash family [symbol] : {0, 1}ⁿ→{0, 1}^{m}, and any obfuscator [symbol] , we define a “boosted” hash family Boos [symbol] ( [symbol] , p), that is sampled as follows:

$$H ← ℋ$$

$$\tilde{H} ← 𝒪 ( {Pad}_{p} ( H ) )$$

$$return \tilde{H}$$

Theorem 3. Let n, m, S: [symbol] → [symbol] be polynomially bounded functions, let i [symbol] be an indistinguishability obfuscator, and let [symbol] ={ [symbol] _{λ}:{0, 1}^{nλ)}→{0, 1}^{m(λ)}} [symbol] be a p.p.t.-sampleable hash family ensemble that is SS-CI for size-S computable functions.

There exists a polynomially-bounded function p: [symbol] → [symbol] such that the (p.p.t.-sampleable) hash family ensemble G={Boos [symbol] ( [symbol] _{λ}, p(λ))} [symbol] is SS-CI for every (S, S)-enumerable relation ensemble R={R_{λ}} [symbol] . Moreover, there exists a p.p.t. algorithm [symbol] such that if E_{λ} is a size-S(λ) circuit that enumerates R_{λ}, then { [symbol] (E_{λ})} [symbol] is an R-avoiding mode of [symbol] .

### 2.2 SS-CI for Enumerable Relations, Directly

Next, we prove that a mild generalization of the construction of Canetti et al. yields, for every constant c>0, a hash family that achieves somewhere statistical correlation intractability for SIZE(λ^{c})-enumerable relations. Besides relying on a computational assumption (circular-secure FHE) that is formally incomparable to IO and LWE, this construction has the advantage that it can yield a public-coin hash family (e.g. if the FHE scheme has pseudorandom ciphertexts). As this advantage is not relevant to the present work, we do not elaborate on it further.

There are several parameters in the construction; we overview them now. First, the parameters describing what we want out of hash family (which all depend on a security parameter λ):
Output length \hat{m}=\hat{m}(λ). This needs to satisfy \hat{m}(λ)≥λ^{Ω(1)} for correlation intractability to be plausible, and also needs to satisfy \hat{m}(λ)≤λ^{O(1)} for the hash family to be efficient. Indeed, it may be helpful to think of \hat{m}(λ) as the “true” security parameter for the hash family. Altogether \hat{m}(λ)=λ^{⊖(1)}.
Input length n=n(λ). This just needs to satisfy n(λ)≤λ^{O(1)} so that the hash family can be efficient.
Circuit size S such that the hash family achieves SS-CI for all size-S enumerable relations R_{λ}⊆{0, 1}^{nλ)}×{0, 1}^{\hat{m}(λ)}.

A central idea in the construction is to interpret hash function's outputs (evaluated) FHE ciphertexts. This introduces a couple more parameters:
We will need to interpret the hash function outputs as encryptions of m-bit messages, where 2^{m} is greater than the number of outputs given by the enumerator for R. In particular it suffices to set m>log₂(S).
The FHE scheme will be used not with security parameter λ, but with a security parameter λ′ that is more closely related to \hat{m}(λ). We will want λ′ to be as large as possible, while still permitting the interpretation of the hash output as an encryption of an m-bit message.

Theorem 4. Let [symbol] [symbol] ε=(Enc, Dec, Eval) be a circular secure secret-key FHE scheme as in Definitions 1 and 2. Let n, \hat{m}, S: [symbol] → [symbol] be polynomially bounded functions with \hat{m}(λ)=λ^{⊖(1)}.

Then the hash family [symbol] ={ [symbol] _{λ}} [symbol] depicted in Section 2.2 is polynomial-time sampleable and SS-CI for the class of size-S enumerable relations.

The directly constructed hash family [symbol] _{λ}={H_{ct}} follows.

Key Sampling: A hash key consists of an [symbol] [symbol] ε ciphertext ct sampled as
1. sk←{0, 1}^{λ′}, where λ′ is an FHE security parameter defined as follows. Let B(·) denote the ratio of ciphertext length to message length as a function of security parameter as in Definition 1, define m:=[log(S(λ))]+1. and define λ′ as the largest integer for which m·B(λ′)≤\hat{m}(λ).
2. ct←Enc(sk, (sk, 0^{Ŝ})), where Ŝ=Ô(S) is the maximum number of bits required to represent a circuit of size S=S(n(λ)).

Evaluation of H_{ct} on input x∈{0, 1}^{n(λ)}
1. Let Cₓ denote a circuit that on input (sk, E)∈{0, 1}^{λ′}×{0, 1}^{Ŝ}, computes as follows:
   (a) (ý₁, . . . , [symbol] ):=E(x), where E is interpreted as a size-S circuit, and each ŷᵢ is truncated or padded to a length of m·B(λ′) bits.
   (b) yᵢ:=Dec(sk, ŷᵢ) for i∈{1, . . . , [symbol] }.
   (c) Output some canonical (e.g. the lexicographically first) z∈{0, 1}^{m}\{y₁, . . . , [symbol] }. (Such a z exists because [symbol] ≤S<2^{m}).
2. Compute and output ŷ:=Eval(Cₓ, ct) padded to length \hat{m}(λ).

### Systems and Methods Implementations

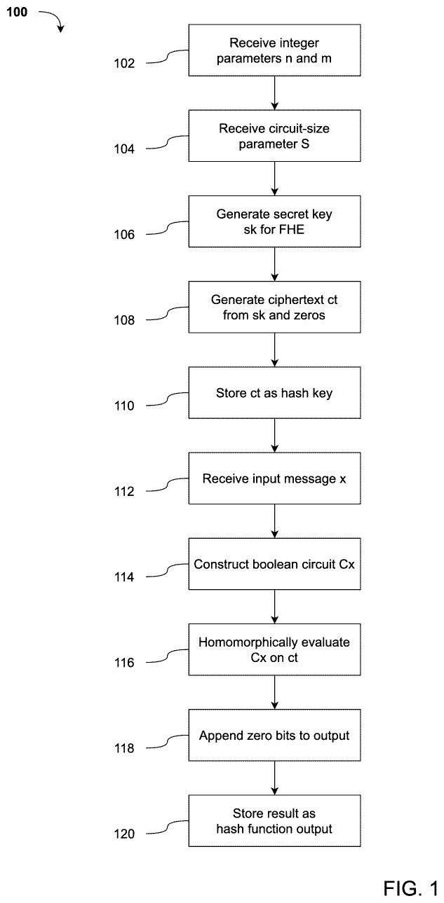

FIG. 1 illustrates a method 100 for generating and evaluating a keyed hash function that incorporates fully homomorphic encryption (FHE) operations to achieve enhanced cryptographic security properties. The method 100 provides a systematic approach for implementing somewhere statistical correlation intractability (SS-CI) for enumerable relations, which may provide security against finding correlated input-output pairs in cryptographic hash operations.

The method 100 begins with a step 102 where integer parameters n and m are received. In some cases, the parameter n may represent a target input length for the keyed hash function, while the parameter m may represent a target output length. These parameters may define the dimensional characteristics of the hash function and may influence the computational complexity and security properties of the resulting cryptographic system. The reception of these parameters in step 102 may establish the foundational specifications that guide subsequent operations within the method 100.

Following parameter reception, the method 100 proceeds to a step 104 where a circuit-size parameter S is received. The circuit-size parameter S may correlate to a security level of the keyed hash function, where larger values of S may correspond to higher security levels and increased resistance to cryptographic attacks. In some cases, the circuit-size parameter S may specify a level of circuit complexity such that the constructed keyed hash function satisfies somewhere-statistical correlation intractability with respect to relations whose circuit complexity does not exceed S. The parameter S may determine the computational resources allocated for the hash function evaluation and may influence the strength of the cryptographic guarantees provided by the system.

The method 100 continues to a step 106 where a secret key sk for FHE is generated. The secret key sk may serve as the foundational cryptographic element that enables homomorphic operations on encrypted data within the hash function construction. In some cases, the secret key sk may be generated using cryptographically secure pseudo-random number generators to ensure unpredictability and resistance to cryptographic attacks. The generation of the secret key sk in step 106 may establish the cryptographic foundation that enables the subsequent FHE operations throughout the method 100.

Following key generation, the method 100 proceeds to a step 108 where a ciphertext. ct is generated from sk and zeros. In some cases, the ciphertext ct may be generated by encrypting a message comprising the secret key sk concatenated with a string of S zero bits using the FHE scheme. The concatenation of sk with zero bits may provide the necessary structure for subsequent homomorphic evaluations while maintaining the security properties of the encryption scheme. The generation of ciphertext ct in step 108 may create the encrypted representation that serves as the hash key for the keyed hash function.

The method 100 then moves to a step 110 where ct is stored as a hash key. The storage of the ciphertext ct as a hash key may enable the system to utilize the encrypted representation for subsequent hash computations while maintaining the confidentiality of the underlying secret key sk. In some cases, the hash key may be stored in secure memory or specialized hardware security modules to prevent unauthorized access or tampering. The storage operation in step 110 may complete the key generation phase of the method 100 and may prepare the system for operational hash computations.

The method 100 proceeds to a step 112 where an input message x is received. The input message x may represent arbitrary data that requires hash computation, including text strings, binary data, or structured information. In some cases, the input message x may undergo preprocessing operations to ensure compatibility with the hash function's input requirements. The reception of the input message x in step 112 may initiate the operational phase of the method 100 where the actual hash computation begins.

Following message reception, the method 100 continues to a step 114 where a boolean circuit Cₓ is constructed. The boolean circuit Cₓ may represent a computational structure that defines the logical operations to be performed on the input message x within the homomorphic encryption framework. In some cases, the boolean circuit Cₓ may be constructed to take as input a pair (sk, E), where E represents a circuit enumerator, and may compute operations including evaluating E on x to obtain a list of candidate outputs, executing FHE decryption procedures on these candidates using the secret key sk, and outputting a canonical string that does not appear in the candidate list. The construction of the boolean circuit Cₓ in step 114 may create the computational framework that enables the homomorphic evaluation of the hash function.

The method 100 then moves to a step 116 where Cₓ is homomorphically evaluated on ct. The homomorphic evaluation may enable the computation of the boolean circuit Cₓ on the encrypted ciphertext ct without requiring decryption of the underlying data. In some cases, the homomorphic evaluation may utilize the properties of the FHE scheme to perform arbitrary computations on encrypted data while preserving the confidentiality of the secret key sk. The homomorphic evaluation in step 116 may generate an encrypted result that represents the hash computation performed on the input message x.

Following homomorphic evaluation, the method 100 proceeds to a step 118 where zero bits are appended to the output. The appending of zero bits may ensure that the output conforms to the specified length requirements defined by the parameter m received in step 102. In some cases, the zero bits may be appended to pad the homomorphically evaluated ciphertext to achieve the target output length m. The padding operation in step 118 may standardize the output format and may ensure compatibility with downstream systems that expect fixed-length hash values.

The method 100 concludes with a step 120 where the result is stored as hash function output. The storage of the result may complete the hash computation process and may make the computed hash value available for subsequent verification, authentication, or integrity checking operations. In some cases, the hash function output may be stored in conjunction with metadata that identifies the input message x and the parameters used during computation. The storage operation in step 120 may finalize the hash computation and may enable the utilization of the computed hash value in cryptographic protocols and applications.

The sequential flow from step 102 through step 120 may provide a comprehensive framework for implementing a keyed hash function with enhanced security properties. The integration of FHE-based cryptographic operations throughout the method 100 may enable the achievement of somewhere statistical correlation intractability for enumerable relations, which may provide robust security guarantees against sophisticated cryptographic attacks. The method 100 may combine parameter configuration, key generation, message processing, circuit construction, homomorphic evaluation, and output formatting to create a complete cryptographic hash system that maintains security while enabling practical implementation.

### FHE Implementation

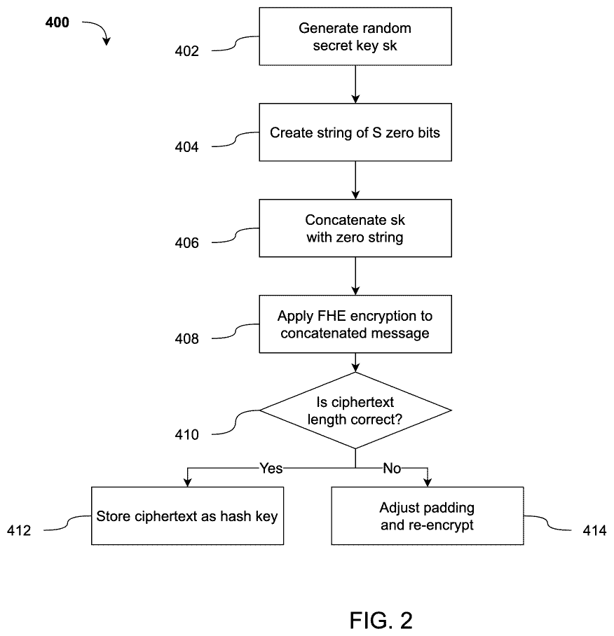

FIG. 2 illustrates a method 400 for generating and evaluating a keyed hash function using fully homomorphic encryption with specialized validation and adjustment mechanisms. The method 400 provides an iterative approach to ensure proper ciphertext formatting and length compliance through systematic verification and correction procedures.

The method 400 begins at a step 402 where a random secret key sk is generated. The secret key sk may serve as the foundational cryptographic element for the FHE scheme and may be generated using cryptographically secure pseudorandom number generators to ensure unpredictability and resistance to various cryptographic attacks. In some cases, the secret key sk may be generated with a security parameter′ that may be related to but distinct from a main security parameter. The security parameter′ may be defined as the largest integer for which m·B(λ′)≤\hat{m}(λ), where B(·) represents the ratio of ciphertext length to message length as a function of the security parameter, and \hat{m}(λ) represents the target output length. The generation of the secret key sk in step 402 may establish the cryptographic foundation that enables subsequent homomorphic operations throughout the method 400.

Following key generation, the method 400 proceeds to a step 404 where a string of S zero bits is created. The string of S zero bits may provide padding material that may be concatenated with the secret key sk to form a composite message for encryption. In some cases, the parameter S may correspond to the circuit-size parameter that defines the complexity level for enumerable relations that the hash function may handle. The creation of the zero bit string in step 404 may prepare the padding component that may be combined with the secret key sk to achieve the desired message structure for FHE encryption.

The method 400 continues to a step 406 where sk is concatenated with the zero string. The concatenation operation may combine the secret key sk with the string of S zero bits to form a composite message that may serve as input to the FHE encryption process. In some cases, the concatenated message may have the form (sk, 0^{S}) where 0^{S} represents the string of S zero bits. The concatenation in step 406 may create the structured input that enables the FHE scheme to encrypt both the secret key and the padding material as a unified ciphertext.

Following concatenation, the method 400 moves to a step 408 where FHE encryption is applied to the concatenated message. The FHE encryption may transform the concatenated message into a ciphertext that preserves the homomorphic properties necessary for subsequent computational operations. In some cases, the FHE encryption may utilize schemes based on Learning With Errors (LWE) assumptions or circular secure FHE schemes that provide enhanced security guarantees. The encryption operation in step 408 may implement circular security where encryptions of the secret key concatenated with messages may be computationally indistinguishable from encryptions of the secret key concatenated with different messages. The FHE encryption may utilize an Eval function with perfect evaluation correctness ensuring that Dec(sk, Eval(C, Enc(sk, x)))=C(x) with probability 1 for any circuit C and input x.

The method 400 then proceeds to a step 410 which includes a decision point to determine if the ciphertext length is correct. The decision point at step 410 may evaluate whether the generated ciphertext conforms to the length requirements specified by the target output length \hat{m}(λ). In some cases, the length verification may compare the actual ciphertext length against the expected length derived from the security parameter′ and the expansion factor B(λ′). The decision logic at step 410 may implement a validation mechanism that ensures the ciphertext meets the dimensional specifications before proceeding to storage or may trigger corrective actions if the length requirements are not satisfied.

If the ciphertext length is correct (Yes branch), the method 400 proceeds to a step 412 where the ciphertext is stored as a hash key. The storage of the ciphertext as a hash key may complete the key generation process and may make the encrypted representation available for subsequent hash computations. In some cases, the hash key may be stored in secure memory or specialized hardware security modules to prevent unauthorized access or tampering. The storage operation in step 412 may finalize the key generation phase and may prepare the system for operational hash function evaluations.

If the ciphertext length is not correct (No branch), the method 400 goes to a step 414 where padding is adjusted and re-encryption is performed. The padding adjustment mechanism in step 414 may modify the zero bit string length or may apply additional formatting operations to achieve the target ciphertext length. In some cases, the adjustment may involve recalculating the security parameter′ or modifying the expansion factor B(λ′) to ensure compatibility with the target output length \hat{m}(λ). Following the padding adjustment, the re-encryption process may generate a new ciphertext using the modified parameters. After step 414, the method 400 returns to step 410 for length verification, creating an iterative loop that continues until the ciphertext length requirements are satisfied.

The iterative validation process between step 410 and step 414 may provide a robust mechanism for ensuring ciphertext format compliance while maintaining the security properties of the FHE scheme. The decision logic at step 410 may implement sophisticated length checking algorithms that account for the various factors affecting ciphertext expansion, including the security parameter, message length, and encryption scheme characteristics. The padding adjustment mechanism in step 414 may utilize adaptive algorithms that systematically modify the input parameters to converge on the target ciphertext length while preserving the cryptographic integrity of the hash key generation process.

The method 400 may incorporate advanced FHE implementations that support different security models and computational requirements. In some cases, the FHE scheme may utilize lattice-based constructions that provide security guarantees under well-established mathematical assumptions such as the LWE problem. The circular security properties implemented in the method 400 may enable the encryption of the secret key itself, which may provide enhanced security guarantees for applications requiring protection against adaptive attacks or key exposure scenarios.

The encryption workflow from step 402 through step 414 may demonstrate a comprehensive approach to FHE-based hash key generation that balances security, efficiency, and format compliance. The systematic progression from key generation through concatenation, encryption, validation, and potential adjustment may ensure that the resulting hash key meets both cryptographic security requirements and practical implementation constraints. The iterative nature of the validation and adjustment process may provide flexibility in handling various parameter configurations while maintaining consistent output formatting across different operational scenarios.

### Computing Architecture

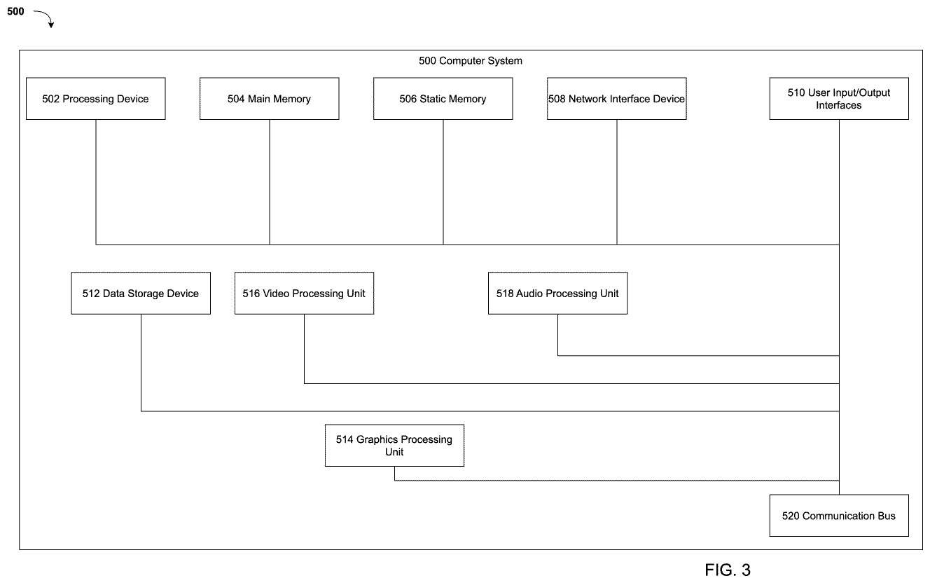

FIG. 3 illustrates a computer system 500 that provides a comprehensive computing architecture for implementing the keyed hash function operations described in the method 100. The computer system 500 may enable the execution of cryptographic hash computations through coordinated operation of multiple specialized components that work together to process input data, perform homomorphic encryption operations, and generate secure hash outputs.

The computer system 500 includes a processing device 502 that serves as the central computational unit for executing the cryptographic algorithms and hash function operations. The processing device 502 may implement the core logic for the method 100, including the generation of secret keys sk, the construction of boolean circuits Cₓ, and the homomorphic evaluation operations described in the step 116. In some cases, the processing device 502 may execute instructions for fully homomorphic encryption schemes based on Learning With Errors (LWE) assumptions or other lattice-based cryptographic constructions. The processing device 502 may coordinate the sequential execution of operations from the step 102 through the step 120, managing the flow of data and computational resources throughout the hash function implementation.

The computer system 500 further includes a main memory 504 that provides volatile storage for active programs and data during hash computation operations. The main memory 504 may store intermediate computational results generated during the homomorphic evaluation processes, including the ciphertext ct generated in the step 108 and the boolean circuit representations constructed in the step 114. In some cases, the main memory 504 may maintain working copies of the secret key sk and the input message x during processing operations. The main memory 504 may provide high-speed access to frequently used data structures and may enable efficient data transfer between the processing device 502 and other system components during cryptographic operations.

A static memory 506 within the computer system 500 offers non-volatile storage for persistent data and system configurations that may be retained across power cycles. The static memory 506 may store the hash function algorithms, cryptographic libraries, and system parameters including the integer parameters n and m received in the step 102 and the circuit-size parameter S received in the step 104. In some cases, the static memory 506 may maintain configuration data that defines the security parameters for the keyed hash function system, including input length n(λ)=λ^{O(1)}, output length \hat{m}(λ)=λ^{⊖(1)}, and circuit size S(λ)=λ^{O(1)} for enumerable relations. The static memory 506 may provide persistent storage for cryptographic constants and algorithm implementations that may be accessed during hash function operations.

The computer system 500 includes a network interface device 508 that enables communication with external networks and systems for data transmission and verification purposes. The network interface device 508 may facilitate the reception of input messages x as described in the step 112, enabling the computer system 500 to receive data from remote sources for hash computation. In some cases, the network interface device 508 may support secure communication protocols that protect the confidentiality and integrity of data transmitted to and from the computer system 500. The network interface device 508 may enable distributed hash function operations where multiple systems collaborate to perform cryptographic computations or where hash results may be transmitted to remote verification systems.

User input/output interfaces 510 within the computer system 500 provide interaction capabilities between users and the hash function system, allowing for data input and output operations. The user input/output interfaces 510 may enable users to provide input messages x for hash computation and may display the hash function outputs generated in the step 120. In some cases, the user input/output interfaces 510 may include keyboard interfaces for text input, display interfaces for result visualization, and other interaction mechanisms that facilitate user control of the hash function operations. The user input/output interfaces 510 may provide mechanisms for users to configure the parameters n, m, and S that define the operational characteristics of the keyed hash function.

A data storage device 512 in the computer system 500 provides long-term storage for hash keys, computed hash values, and cryptographic algorithms. The data storage device 512 may store the ciphertext ct that serves as the hash key as described in the step 110, maintaining the encrypted representation in secure storage that prevents unauthorized access or tampering. In some cases, the data storage device 512 may implement specialized security features including encryption at rest, access controls, and integrity verification mechanisms that protect stored cryptographic data. The data storage device 512 may maintain historical records of hash computations and may provide backup storage for cryptographic keys and system configurations.

The computer system 500 incorporates a graphics processing unit 514 that may be utilized for parallel processing operations to accelerate hash computations on large datasets. The graphics processing unit 514 may provide computational acceleration for the homomorphic evaluation operations described in the step 116, leveraging parallel processing capabilities to perform multiple cryptographic operations simultaneously. In some cases, the graphics processing unit 514 may implement specialized algorithms for lattice-based cryptographic operations that may benefit from parallel execution architectures. The graphics processing unit 514 may enable the computer system 500 to process multiple input messages x concurrently or to perform complex boolean circuit evaluations with enhanced computational efficiency.

A video processing unit 516 within the computer system 500 manages video-related computations and processing tasks that may support visualization and monitoring of hash function operations. The video processing unit 516 may generate graphical representations of hash computation progress, system status information, and cryptographic operation results. In some cases, the video processing unit 516 may provide real-time visualization of the hash function workflow, displaying the progression through the steps 102 through 120 and highlighting the current operational state of the system. The video processing unit 516 may support diagnostic and monitoring capabilities that enable system administrators to observe the performance and status of cryptographic operations.

An audio processing unit 518 in the computer system 500 processes audio signals and manages sound-related operations that may provide auditory feedback during hash function operations. The audio processing unit 518 may generate audio notifications for completed hash computations, system alerts, or error conditions that may occur during cryptographic processing. In some cases, the audio processing unit 518 may provide accessibility features that enable users with visual impairments to interact with the hash function system through audio interfaces. The audio processing unit 518 may support voice input capabilities that allow users to provide input messages x or system commands through speech recognition interfaces.

A communication bus 520 connects all components within the computer system 500, enabling data transfer and coordination between the processing device 502, the main memory 504, the static memory 506, the network interface device 508, the user input/output interfaces 510, the data storage device 512, the graphics processing unit 514, the video processing unit 516, and the audio processing unit 518. The communication bus 520 facilitates the flow of information and control signals throughout the computer system 500, ensuring proper coordination and operation of all connected components during hash function execution. In some cases, the communication bus 520 may implement high-speed data transfer protocols that minimize latency during cryptographic operations and may provide sufficient bandwidth to support the data-intensive operations associated with homomorphic encryption and hash computation.

The communication bus 520 may coordinate the transfer of the secret key sk from the processing device 502 to the main memory 504 during the step 106, may facilitate the movement of the ciphertext ct from the processing device 502 to the data storage device 512 during the step 110, and may enable the transfer of input messages x from the network interface device 508 or the user input/output interfaces 510 to the processing device 502 during the step 112. The communication bus 520 may provide the interconnection infrastructure that enables the coordinated operation of all system components during the execution of the method 100, ensuring that data flows efficiently between components while maintaining the security and integrity of cryptographic operations.

The architecture of the computer system 500 may support the implementation of keyed hash functions with configurable security parameters that may be adjusted based on application requirements and threat models. The system may accommodate input length parameters n(λ)=λ^{O(1)} that scale polynomially with the security parameter λ, enabling the processing of variable-length input messages while maintaining computational efficiency. The output length parameter \hat{m}(λ)=λ^{⊖(1)} may provide hash outputs with lengths that grow polynomially with the security parameter, ensuring adequate security margins while maintaining practical output sizes for cryptographic applications.

The circuit size parameter S(λ)=λ^{O(1)} for enumerable relations may define the complexity level of relations that the hash function may handle while maintaining somewhere statistical correlation intractability properties. The computer system 500 may dynamically adjust computational resources based on the specified circuit size parameter, allocating additional processing capacity through the graphics processing unit 514 or other specialized components when larger circuit sizes may be required. The flexible architecture of the computer system 500 may enable the implementation of hash functions with varying security levels and computational requirements, providing adaptability for different cryptographic applications and operational environments.

### System Architecture

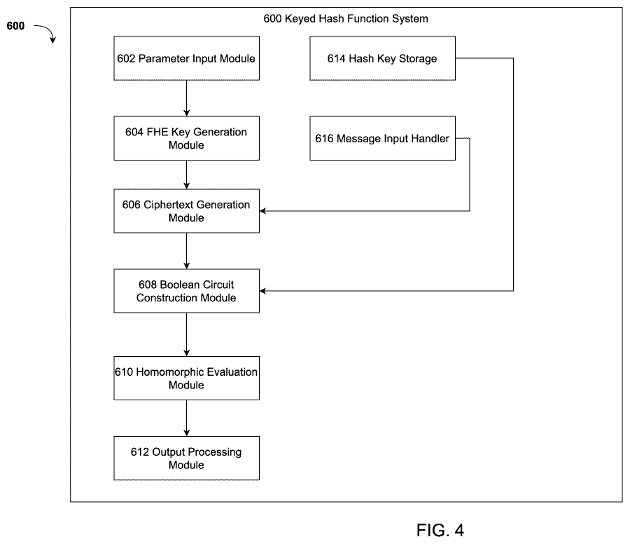

FIG. 4 illustrates a keyed hash function system 600 that provides a modular architecture for implementing cryptographic hash operations with enhanced security properties through fully homomorphic encryption. The keyed hash function system 600 may enable the systematic processing of input data through specialized modules that coordinate to generate secure hash outputs while maintaining somewhere statistical correlation intractability for enumerable relations.

The keyed hash function system 600 begins with a parameter input module 602 that receives and processes the foundational configuration parameters for the hash function operation. The parameter input module 602 may receive integer parameters n and m that define the input and output dimensions of the hash function, where n may represent the target input length and m may represent the target output length. In some cases, the parameter input module 602 may receive a circuit-size parameter S that correlates to the security level of the keyed hash function, where larger values of S may correspond to higher security levels and increased resistance to cryptographic attacks. The parameter input module 602 may validate the received parameters to ensure compatibility with the underlying cryptographic schemes and may establish the operational boundaries for subsequent processing modules within the keyed hash function system 600.

Following parameter configuration, the keyed hash function system 600 proceeds to an FHE key generation module 604 that creates the cryptographic foundation for homomorphic operations. The FHE key generation module 604 may generate a secret key sk using cryptographically secure pseudorandom number generators to ensure unpredictability and resistance to various cryptographic attacks. In some cases, the FHE key generation module 604 may implement key generation algorithms based on Learning With Errors (LWE) assumptions or other lattice-based cryptographic constructions that provide robust security guarantees. The FHE key generation module 604 may coordinate with the parameter input module 602 to ensure that the generated secret key sk conforms to the dimensional and security requirements specified by the input parameters.

The keyed hash function system 600 continues to a ciphertext generation module 606 that creates encrypted representations using the secret key sk generated by the FHE key generation module 604. The ciphertext generation module 606 may encrypt messages comprising the secret key sk concatenated with a string of \tilde{S} zero bits, where \tilde{S}=Õ(S) represents the maximum number of bits required to represent a circuit of size S. In some cases, the ciphertext generation module 606 may implement circular secure FHE schemes where encryptions of the secret key concatenated with messages may be computationally indistinguishable from encryptions of the secret key concatenated with different messages. The ciphertext generation module 606 may generate a ciphertext ct that serves as the hash key for subsequent cryptographic operations, ensuring that the encrypted representation maintains the homomorphic properties necessary for secure computation.

The keyed hash function system 600 incorporates a boolean circuit construction module 608 that creates computational structures for processing input messages within the homomorphic encryption framework. The boolean circuit construction module 608 may construct circuits Cₓ that interpret input E as a size-S circuit and perform operations including evaluating E(x) to obtain a list of outputs, decrypting each output using FHE decryption, and outputting a canonical m-bit string not in the decrypted list. In some cases, the boolean circuit construction module 608 may handle circuits with polynomial size bounds and may ensure that the number of enumerated outputs [symbol] ≤S≤2^{m} to guarantee existence of canonical output strings. The boolean circuit construction module 608 may receive input from both the ciphertext generation module 606 and a message input handler 616, enabling the coordinated processing of encrypted data and input messages through the constructed boolean circuits.

Following circuit construction, the keyed hash function system 600 proceeds to a homomorphic evaluation module 610 that performs encrypted computations on the boolean circuits without requiring decryption of the underlying data. The homomorphic evaluation module 610 may execute the boolean circuit Cₓ on the ciphertext ct generated by the ciphertext generation module 606, utilizing the homomorphic properties of the FHE scheme to perform arbitrary computations while preserving the confidentiality of the secret key sk. In some cases, the homomorphic evaluation module 610 may implement evaluation algorithms with perfect evaluation correctness, ensuring that decryption of the homomorphically evaluated result produces the same output as direct evaluation of the circuit on the plaintext data. The homomorphic evaluation module 610 may coordinate with the boolean circuit construction module 608 to ensure proper circuit representation and may manage computational resources to optimize the efficiency of homomorphic operations.

The keyed hash function system 600 includes an output processing module 612 that formats and finalizes the results of the homomorphic evaluation operations. The output processing module 612 may process the encrypted results generated by the homomorphic evaluation module 610 to produce hash outputs that conform to the dimensional specifications defined by the parameter input module 602. In some cases, the output processing module 612 may append zero bits to the homomorphically evaluated ciphertext to achieve the target output length m specified during parameter configuration. The output processing module 612 may implement padding algorithms that ensure consistent output formatting while maintaining the cryptographic integrity of the hash computation results.

The keyed hash function system 600 incorporates a hash key storage 614 component. that provides secure storage for the generated hash keys and related cryptographic materials. The hash key storage 614 may store the ciphertext ct generated by the ciphertext generation module 606, maintaining the encrypted representation in secure memory that prevents unauthorized access or tampering. In some cases, the hash key storage 614 may implement specialized security features including encryption at rest, access controls, and integrity verification mechanisms that protect stored cryptographic data. The hash key storage 614 may coordinate with multiple modules within the keyed hash function system 600 to provide secure access to hash keys during computational operations while maintaining strict security boundaries.

The keyed hash function system 600 includes a message input handler 616 that manages the reception and preprocessing of input messages that require hash computation. The message input handler 616 may receive input messages x from various sources including network interfaces, user input systems, or data storage devices, and may perform preprocessing operations to ensure compatibility with the hash function requirements. In some cases, the message input handler 616 may implement input validation mechanisms that verify the format and dimensions of received messages against the parameters configured by the parameter input module 602. The message input handler 616 may provide input to the boolean circuit construction module 608, enabling the system to process incoming messages through the homomorphic evaluation pipeline while maintaining data integrity and security.

The data flow within the keyed hash function system 600 may follow a systematic progression from parameter configuration through key generation, ciphertext creation, circuit construction, homomorphic evaluation, and output processing. The parameter input module 602 may establish the operational parameters that guide the behavior of subsequent modules, while the FHE key generation module 604 may create the cryptographic foundation that enables secure computation. The ciphertext generation module 606 may transform the secret key and padding material into encrypted representations that serve as hash keys, while the boolean circuit construction module 608 may create the computational structures necessary for processing input messages.

The integration between the hash key storage 614 and other components within the keyed hash function system 600 may provide secure access to cryptographic materials while maintaining strict security boundaries. The hash key storage 614 may coordinate with the ciphertext generation module 606 to store newly generated hash keys and may provide secure access to the homomorphic evaluation module 610 during computational operations. In some cases, the hash key storage 614 may implement key rotation mechanisms that periodically update stored hash keys to maintain long-term security while ensuring continuity of hash function operations.

The message input handler 616 may coordinate with the boolean circuit construction module 608 to ensure proper integration of input messages into the circuit construction process. The message input handler 616 may provide preprocessed input messages x to the boolean circuit construction module 608, which may incorporate these messages into the boolean circuit Cₓ that defines the computational operations to be performed during homomorphic evaluation. The coordination between the message input handler 616 and the boolean circuit construction module 608 may enable the keyed hash function system 600 to process variable-length input messages while maintaining consistent computational structures and security properties.

The modular architecture of the keyed hash function system 600 may provide flexibility in implementing different cryptographic schemes and security parameters while maintaining a consistent operational framework. The separation of concerns between parameter configuration, key generation, ciphertext creation, circuit construction, homomorphic evaluation, and output processing may enable independent optimization of each component while ensuring proper coordination through well-defined interfaces. The keyed hash function system 600 may support configurable security parameters that may be adjusted based on application requirements and threat models, providing adaptability for different cryptographic applications and operational environments.

### Cryptographic Framework

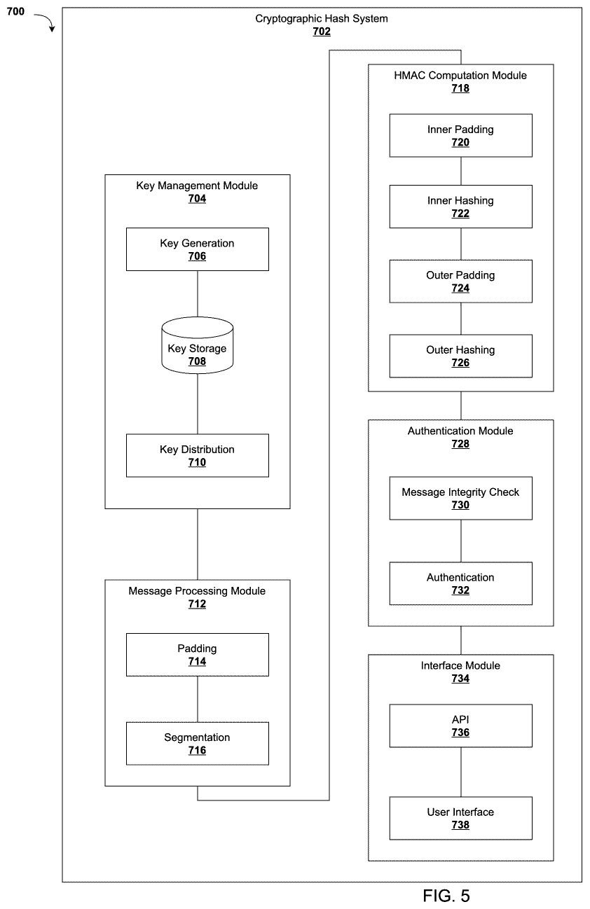

FIG. 5 illustrates a cryptographic hash system 702 that provides a comprehensive framework for implementing secure message authentication and integrity verification through coordinated operation of multiple specialized modules. The cryptographic hash system 702 may enable the systematic processing of cryptographic operations through modular components that work together to generate secure hash outputs while maintaining enhanced security properties including somewhere statistical correlation intractability for enumerable relations.

The cryptographic hash system 702 includes a key management module 704 that provides foundational cryptographic services for the generation, storage, and distribution of cryptographic keys throughout the system. The key management module 704 may coordinate with other modules within the cryptographic hash system 702 to ensure that cryptographic keys maintain proper security properties and remain available for hash computation operations. In some cases, the key management module 704 may implement security policies that govern key lifecycle management and may provide access controls that restrict key usage to authorized operations within the cryptographic hash system 702.

The key management module 704 contains three specialized components that handle different aspects of cryptographic key operations. A key generation 706 component creates cryptographic keys for the cryptographic hash system 702 using cryptographically secure pseudorandom number generators to ensure unpredictability and resistance to various cryptographic attacks. The key generation 706 may implement key generation algorithms based on established cryptographic standards and may coordinate with the parameter input module 602 to ensure that generated keys conform to the dimensional and security requirements specified for the hash function operations. In some cases, the key generation 706 may generate keys with lengths that match or exceed the hash function output length to prevent brute-force attacks and may implement key derivation functions that create multiple keys from master key material.

A key storage 708 component within the key management module 704 maintains the generated keys in a secure repository that prevents unauthorized access or tampering. The key storage 708 may implement specialized security features including encryption at rest, hardware security module integration, and access logging mechanisms that protect stored cryptographic data. In some cases, the key storage 708 may coordinate with the hash key storage 614 to provide unified key management across different components of the cryptographic hash system 702. The key storage 708 may maintain multiple versions of cryptographic keys to support key rotation operations and may implement backup and recovery mechanisms that ensure key availability during system maintenance or failure scenarios.

A key distribution 710 component handles the secure transfer of keys to authorized entities within the cryptographic hash system 702 and external systems that require access to cryptographic keys for verification operations. The key distribution 710 may implement secure communication protocols including Transport Layer Security (TLS) or Internet Protocol Security (IPSec) to protect keys during transmission. In some cases, the key distribution 710 may utilize key agreement protocols such as Diffie-Hellman or RSA-based key exchange mechanisms to establish shared keys between communicating parties without transmitting the keys directly. The key distribution 710 may coordinate with the network interface device 508 to enable secure key exchange over network connections while maintaining the confidentiality and integrity of distributed cryptographic material.

The cryptographic hash system 702 includes a message processing module 712 that. prepares input messages for hash computation operations through standardized formatting and segmentation procedures. The message processing module 712 may receive input messages from the message input handler 616 and may perform preprocessing operations to ensure compatibility with the hash function requirements. In some cases, the message processing module 712 may implement input validation mechanisms that verify the format and dimensions of received messages against the parameters configured within the cryptographic hash system 702.

The message processing module 712 includes a padding 714 component that adjusts message length to meet algorithm requirements and ensure proper block alignment for hash computation operations. The padding 714 may implement standardized padding schemes such as PKCS7 or bit padding that append specific patterns to input messages to achieve the target block size. In some cases, the padding 714 may coordinate with the boolean circuit construction module 608 to ensure that padded messages conform to the input requirements for homomorphic evaluation operations. The padding 714 may handle variable-length input messages by applying consistent padding algorithms that maintain deterministic output while preventing padding-based attacks that could compromise the security of hash operations.

A segmentation 716 component within the message processing module 712 divides messages into appropriate blocks for processing by the hash function algorithms. The segmentation 716 may partition large input messages into fixed-size blocks that match the processing capabilities of the underlying hash algorithms and may coordinate with the homomorphic evaluation module 610 to ensure efficient processing of segmented data. In some cases, the segmentation 716 may implement block chaining mechanisms that maintain dependencies between message segments while enabling parallel processing of independent blocks. The segmentation 716 may handle messages that exceed the block size limitations of the hash function by creating sequential processing workflows that maintain the integrity and security properties of the hash computation across multiple blocks.

The cryptographic hash system 702 incorporates an HMAC computation module 718 that implements a four-stage process for generating Hash-based Message Authentication Codes through coordinated cryptographic operations. The HMAC computation module 718 may provide message authentication and integrity verification capabilities by combining cryptographic hash functions with secret keys in a standardized computational framework. In some cases, the HMAC computation module 718 may coordinate with the key management module 704 to obtain cryptographic keys and may utilize the output from the message processing module 712 to perform hash computations on properly formatted input data.

The HMAC computation module 718 comprises four specialized components that. implement the standardized HMAC algorithm through sequential processing stages. An inner padding 720 component applies padding operations to the inner computation layer by performing XOR operations between the secret key and a predefined inner pad constant. The inner padding 720 may implement the standard inner pad constant of 0×36 repeated to match the block size of the underlying hash function. In some cases, the inner padding 720 may coordinate with the key storage 708 to obtain the secret key and may ensure that the key length matches the block size requirements through key derivation or truncation operations as needed.

An inner hashing 722 component performs the initial hash computation by applying the cryptographic hash function to the concatenation of the inner padded key and the input message. The inner hashing 722 may utilize hash algorithms such as SHA-256 or SHA-3 that provide collision resistance and preimage resistance properties. In some cases, the inner hashing 722 may coordinate with the segmentation 716 to process large messages through iterative hash operations that maintain the security properties of the hash function across multiple message blocks. The inner hashing 722 may generate intermediate hash values that serve as input to subsequent processing stages within the HMAC computation module 718.

An outer padding 724 component applies padding operations to the outer computation layer by performing XOR operations between the secret key and a predefined outer pad constant. The outer padding 724 may implement the standard outer pad constant of 0×5C repeated to match the block size of the underlying hash function. In some cases, the outer padding 724 may utilize the same secret key obtained by the inner padding 720 while applying different padding constants to create distinct computational paths for the inner and outer hash operations. The outer padding 724 may ensure that the outer padding operations maintain independence from the inner padding operations while utilizing the same cryptographic key material.

An outer hashing 726 component completes the final hash computation by applying the cryptographic hash function to the concatenation of the outer padded key and the result from the inner hashing 722. The outer hashing 726 may generate the final HMAC output that serves as the message authentication code for the input data. In some cases, the outer hashing 726 may coordinate with the output processing module 612 to ensure that the final HMAC output conforms to the dimensional specifications and formatting requirements of the cryptographic hash system 702. The outer hashing 726 may implement the mathematical relationship HMAC=Hash((Key⊕OPAD)∥Inner Hash) where OPAD represents the outer padding constant and the inner hash represents the output from the inner hashing 722.

The cryptographic hash system 702 includes an authentication module 728 that provides verification capabilities for message integrity and sender authentication through coordinated validation operations. The authentication module 728 may utilize the HMAC outputs generated by the HMAC computation module 718 to perform verification operations that confirm the authenticity and integrity of received messages. In some cases, the authentication module 728 may coordinate with the key management module 704 to obtain verification keys and may implement timing-attack resistant comparison algorithms that prevent information leakage during verification operations.

The authentication module 728 contains two specialized components that handle different aspects of cryptographic verification operations. A message integrity check 730 component verifies that messages have not been altered during transmission or storage by computing HMAC values for received messages and comparing these values with transmitted authentication codes. The message integrity check 730 may implement constant-time comparison algorithms that prevent timing attacks during HMAC verification operations. In some cases, the message integrity check 730 may coordinate with the HMAC computation module 718 to recompute HMAC values for received messages using the same cryptographic keys and algorithms used during the original computation. The message integrity check 730 may detect unauthorized modifications to message content by identifying discrepancies between computed and received HMAC values.

An authentication 732 component validates the identity of message senders based on the correctness of the HMAC values and may implement access control mechanisms that grant or deny access to resources based on authentication results. The authentication 732 may maintain databases of authorized entities and their associated cryptographic keys to enable identity verification operations. In some cases, the authentication 732 may coordinate with the key distribution 710 to obtain verification keys for different entities and may implement authentication protocols that support multiple verification methods including shared key authentication and public key authentication schemes. The authentication 732 may generate authentication logs that record successful and failed authentication attempts for security monitoring and compliance purposes.

The cryptographic hash system 702 incorporates an interface module 734 that provides access mechanisms for external systems and users to interact with the cryptographic hash functionality through standardized interfaces. The interface module 734 may enable programmatic access to hash computation operations and may provide user-friendly interfaces for system administration and monitoring operations. In some cases, the interface module 734 may coordinate with the user input/output interfaces 510 to provide local access capabilities and may utilize the network interface device 508 to enable remote access to cryptographic services.

The interface module 734 includes an API 736 component that provides programmatic access to the cryptographic hash system 702 functions through standardized application programming interfaces. The API 736 may implement common functions including generateHMAC, verifyHMAC, generatekey, and rotatekey that enable external applications to utilize the cryptographic capabilities of the cryptographic hash system 702. In some cases, the API 736 may implement secure communication protocols such as TLS to protect API calls from interception or tampering during transmission. The API 736 may provide authentication mechanisms that verify the identity of calling applications and may implement rate limiting and access controls that prevent unauthorized or excessive usage of cryptographic resources.

A user interface 738 component offers a graphical interface for user interaction with the cryptographic hash system 702 that enables administrators to manage keys, configure system parameters, and monitor operational status. The user interface 738 may provide visualization capabilities that display hash computation progress, system performance metrics, and security event information. In some cases, the user interface 738 may coordinate with the video processing unit 516 to generate graphical representations of system status and may utilize the audio processing unit 518 to provide auditory notifications for system events. The user interface 738 may implement role-based access controls that restrict administrative functions to authorized users and may provide audit logging capabilities that record user actions for compliance and security monitoring purposes.

The cryptographic hash system 702 may support indistinguishability obfuscation (iO) capabilities that enable the system to boost hash families that are somewhere statistical correlation intractable for computable functions to become somewhere statistical correlation intractable for enumerable relations. The integration of iO capabilities within the cryptographic hash system 702 may coordinate with the boolean circuit construction module 608 to create obfuscated circuit representations that maintain functional equivalence while hiding implementation details. In some cases, the cryptographic hash system 702 may utilize the processing device 502 and the graphics processing unit 514 to perform the computational operations associated with indistinguishability obfuscation while maintaining the security properties of the underlying hash functions.

The cryptographic hash system 702 may be configured for obfuscation-friendly applications where current obfuscation techniques provide limited security guarantees but the hash function maintains security properties under obfuscation operations. The system may implement specialized algorithms that preserve correlation intractability properties even when the hash function implementation may be obfuscated for deployment in untrusted environments. In some cases, the cryptographic hash system 702 may coordinate with the static memory 506 to store obfuscated hash function implementations and may utilize the main memory 504 to perform obfuscated computations while maintaining the confidentiality of the underlying cryptographic algorithms and key material.

The modular architecture of the cryptographic hash system 702 may enable independent optimization and configuration of each component while maintaining proper coordination through well-defined interfaces and data flow pathways. The key management. module 704 may provide cryptographic foundation services that support the operations of the message processing module 712, the HMAC computation module 718, and the authentication module 728. The interface module 734 may provide external access capabilities that enable integration with broader cryptographic infrastructures while maintaining the security boundaries established by the other modules within the cryptographic hash system 702.

### Hardware Implementation

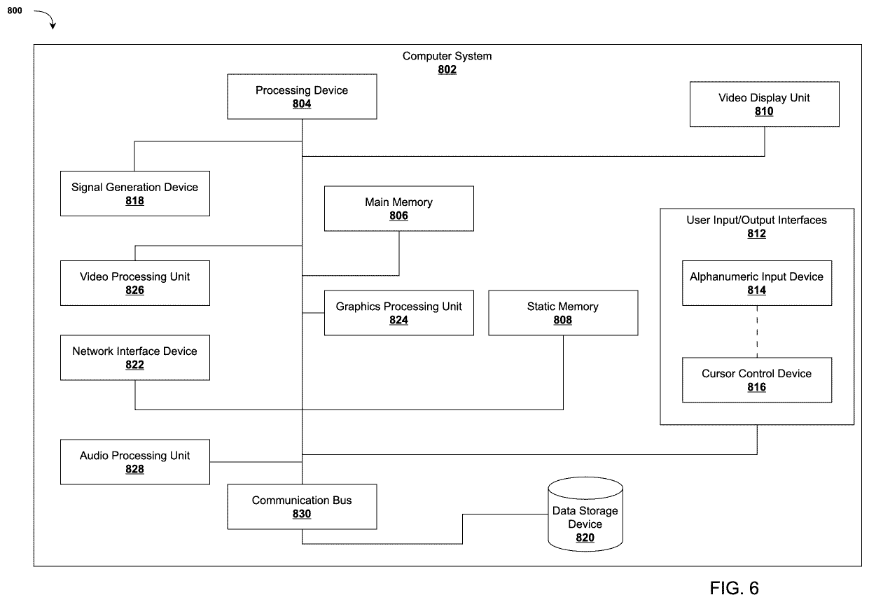

FIG. 6 illustrates a computer system 800 that provides a dual-configuration architecture for implementing cryptographic hash function operations through coordinated processing capabilities and comprehensive input/output systems. The computer system 800 may enable enhanced computational performance for homomorphic encryption operations through specialized hardware configurations that support parallel processing and distributed computational workloads.

The computer system 800 includes a processing device 802 that serves as a primary computational unit for executing cryptographic algorithms and hash function operations within the first processing configuration. The processing device 802 may implement core logic for homomorphic evaluation operations and may coordinate with specialized processing units to perform complex cryptographic computations. In some cases, the processing device 802 may execute instructions for fully homomorphic encryption schemes and may manage the sequential execution of hash function operations while coordinating data flow between multiple system components.

A main memory 804 within the computer system 800 provides volatile storage for active programs and data during cryptographic operations in the first processing configuration. The main memory 804 may store intermediate computational results generated during homomorphic evaluation processes and may maintain working copies of ciphertext data during hash computation operations. In some cases, the main memory 804 may provide high-speed access to frequently used cryptographic data structures and may enable efficient data transfer between the processing device 802 and other system components during complex mathematical operations.

The computer system 800 incorporates a static memory 806 that offers non-volatile storage for persistent data and system configurations within the first processing configuration. The static memory 806 may store cryptographic algorithms, hash function implementations, and system parameters that define the operational characteristics of the keyed hash function system. In some cases, the static memory 806 may maintain configuration data including security parameters and algorithm constants that may be accessed during hash function operations while providing persistent storage across power cycles.

A network interface device 808 within the computer system 800 enables communication capabilities for the first processing configuration, facilitating data exchange with external systems and networks. The network interface device 808 may support secure communication protocols that protect the confidentiality and integrity of cryptographic data transmitted to and from the computer system 800. In some cases, the network interface device 808 may enable distributed hash function operations where multiple systems collaborate to perform cryptographic computations or where hash results may be transmitted to remote verification systems.

The computer system 800 includes a video display unit 810 that provides visual output. capabilities for displaying hash computation results and system status information. The video display unit 810 may generate graphical representations of cryptographic operation progress and may display hash function outputs in various formats for user verification and analysis. In some cases, the video display unit 810 may coordinate with the output processing module 612 to display formatted hash results and may provide real-time visualization of computational progress during complex homomorphic evaluation operations.

User input/output interfaces 812 within the computer system 800 provide interaction capabilities between users and the hash function system for the first processing configuration. The user input/output interfaces 812 may enable users to provide input messages for hash computation and may facilitate the configuration of system parameters that define hash function behavior. In some cases, the user input/output interfaces 812 may coordinate with the message input handler 616 to receive input data and may provide mechanisms for users to monitor and control cryptographic operations.

An alphanumeric input device 814 within the computer system 800 allows text and numerical input for system configuration and data entry operations. The alphanumeric input device 814 may enable users to enter cryptographic parameters, input messages, and system commands through keyboard interfaces. In some cases, the alphanumeric input device 814 may provide secure input capabilities that protect sensitive data during entry and may coordinate with the user input/output interfaces 812 to facilitate comprehensive user interaction with the cryptographic hash system.

A cursor control device 816 in the computer system 800 provides pointing and selection capabilities that enable users to interact with graphical interfaces and system controls. The cursor control device 816 may facilitate navigation through system menus and may enable precise selection of configuration options and operational parameters. In some cases, the cursor control device 816 may coordinate with the video display unit 810 to provide visual feedback during user interaction and may support advanced interaction modes for complex cryptographic system management.

The computer system 800 incorporates a signal generation device 818 that handles signal processing operations within the first processing configuration. The signal generation device 818 may generate control signals that coordinate operations between different system components and may provide timing signals that synchronize cryptographic computations. In some cases, the signal generation device 818 may coordinate with the communication bus 830 to manage data transfer timing and may provide interrupt signals that enable responsive system behavior during hash function operations.

A data storage device 820 within the computer system 800 provides long-term storage for hash keys, computed hash values, and cryptographic algorithms in the first processing configuration. The data storage device 820 may store ciphertext representations that serve as hash keys and may maintain historical records of hash computations for audit and verification purposes. In some cases, the data storage device 820 may implement specialized security features including encryption at rest and access controls that protect stored cryptographic data from unauthorized access or tampering.

The computer system 800 includes a network interface device 822 that provides additional network communication capabilities for the first processing configuration, enabling redundant or specialized network connections. The network interface device 822 may support different network protocols or connection types compared to the network interface device 808 and may provide enhanced bandwidth or security features for specific cryptographic applications. In some cases, the network interface device 822 may enable dedicated connections for key distribution operations or may provide isolated network access for sensitive cryptographic communications.

A graphics processing unit 824 within the computer system 800 provides parallel processing capabilities that may accelerate cryptographic computations through specialized hardware architectures. The graphics processing unit 824 may perform multiple homomorphic evaluation operations simultaneously and may provide computational acceleration for complex mathematical operations associated with fully homomorphic encryption schemes. In some cases, the graphics processing unit 824 may coordinate with the homomorphic evaluation module 610 to perform parallel circuit evaluations and may utilize specialized algorithms optimized for parallel execution architectures.

The computer system 800 incorporates a video processing unit 826 that manages video-related computations and processing tasks for the first processing configuration. The video processing unit 826 may generate visual representations of hash computation progress and may provide real-time monitoring capabilities for cryptographic operations. In some cases, the video processing unit 826 may coordinate with the video display unit 810 to provide enhanced visualization features and may support diagnostic displays that enable system administrators to monitor the performance and status of hash function operations.

An audio processing unit 828 within the computer system 800 processes audio signals and manages sound-related operations that may provide auditory feedback during cryptographic operations. The audio processing unit 828 may generate audio notifications for completed hash computations and may provide accessibility features for users with visual impairments. In some cases, the audio processing unit 828 may support voice input capabilities that enable users to provide system commands through speech recognition interfaces and may coordinate with the user input/output interfaces 812 to provide comprehensive interaction modalities.

A communication bus 830 connects all components within the first processing configuration of the computer system 800, enabling data transfer and coordination between the processing device 802, the main memory 804, the static memory 806, the network interface device 808, the video display unit 810, the user input/output interfaces 812, the alphanumeric input device 814, the cursor control device 816, the signal generation device 818, the data storage device 820, the network interface device 822, the graphics processing unit 824, the video processing unit 826, and the audio processing unit 828. The communication bus 830 may facilitate high-speed data transfer protocols that minimize latency during cryptographic operations and may provide sufficient bandwidth to support data-intensive operations associated with homomorphic encryption and hash computation.

The computer system 800 incorporates a second processing configuration that includes a processing device 804 serving as an additional computational unit for executing cryptographic hash function algorithms and related operations. The processing device 804 may provide computational redundancy or specialized processing capabilities that complement the operations of the processing device 802. In some cases, the processing device 804 may handle specific aspects of hash computation operations or may provide backup processing capabilities that ensure system availability during maintenance or failure scenarios.

A main memory 806 within the second processing configuration provides temporary storage for active data and program instructions during hash computation processes. The main memory 806 may coordinate with the main memory 804 to provide distributed memory capabilities or may serve specialized functions within the dual-configuration architecture. In some cases, the main memory 806 may store different types of cryptographic data compared to the main memory 804 and may enable parallel processing workflows that utilize both memory systems simultaneously.

The second processing configuration includes a static memory 808 that offers non-volatile storage for persistent data and system configurations. The static memory 808 may store backup copies of cryptographic algorithms and system parameters or may maintain specialized configuration data for the second processing configuration. In some cases, the static memory 808 may coordinate with the static memory 806 to provide redundant storage capabilities and may ensure system continuity during component failures or maintenance operations.

A network interface device 822 within the second processing configuration enables communication with external systems and networks for data transmission and verification purposes. The network interface device 822 may provide independent network connectivity for the second processing configuration and may enable distributed processing operations that utilize multiple network connections simultaneously. In some cases, the network interface device 822 may support different network protocols or security features compared to the network interface devices in the first processing configuration.

The second processing configuration incorporates a data storage device 820 that provides long-term storage for cryptographic data and system files. The data storage device 820 may coordinate with the data storage device 820 to provide distributed storage capabilities or may serve specialized storage functions within the dual-configuration architecture. In some cases, the data storage device 820 may implement different security features or storage technologies compared to the data storage device 820 and may provide enhanced performance or capacity for specific cryptographic applications.

User input/output interfaces 812 within the second processing configuration facilitate interaction between users and the computer system 800 through the second processing pathway. The user input/output interfaces 812 may provide redundant or specialized interaction capabilities compared to the user input/output interfaces 812 and may enable users to access different aspects of the cryptographic hash system through multiple interface pathways. In some cases, the user input/output interfaces 812 may support different interaction modalities or security features and may coordinate with the user input/output interfaces 812 to provide comprehensive user access capabilities.

A graphics processing unit 824 within the second processing configuration provides additional parallel processing capabilities for cryptographic computations. The graphics processing unit 824 may coordinate with the graphics processing unit 824 to provide distributed parallel processing or may handle specialized computational tasks within the dual-configuration architecture. In some cases, the graphics processing unit 824 may utilize different processing algorithms or hardware architectures compared to the graphics processing unit 824 and may provide enhanced computational performance for specific types of cryptographic operations.

The second processing configuration includes a machine readable medium that offers additional storage capabilities for system data and programs. The machine readable medium may store specialized software implementations or may provide portable storage capabilities that enable system mobility or backup operations. In some cases, the machine readable medium may contain cryptographic algorithms optimized for the second processing configuration and may enable system deployment in different operational environments.

A video processing unit 826 within the second processing configuration handles video-related processing tasks and may coordinate with the video processing unit 826 to provide enhanced video capabilities. The video processing unit 826 may support different video processing algorithms or output formats and may enable specialized visualization features for cryptographic operations. In some cases, the video processing unit 826 may provide independent video processing capabilities that enable simultaneous operation of multiple video outputs or may support advanced visualization features for complex cryptographic system monitoring.

A communication bus 830 connects all components within the second processing configuration, enabling data transfer and coordination between the processing device 804, the main memory 806, the static memory 808, the network interface device 822, the data storage device 820, the user input/output interfaces 812, the graphics processing unit 824, the machine readable medium, the video processing unit 826, and the audio processing unit 828. The communication bus 830 may implement different data transfer protocols and may provide specialized connectivity features for the second processing configuration.

An audio processing unit 828 within the second processing configuration manages audio operations and may coordinate with the audio processing unit 828 to provide enhanced audio capabilities. The audio processing unit 828 may support different audio processing algorithms or output formats and may enable specialized audio features for cryptographic system interaction. In some cases, the audio processing unit 828 may provide independent audio processing capabilities that enable simultaneous operation of multiple audio outputs or may support advanced accessibility features for users with different interaction requirements.

The coordination between the computer system 802 and the processing device 804 through their respective communication buses may enable distributed processing work-flows that utilize both processing configurations simultaneously. The communication bus 830 may coordinate data transfer operations between the two processing configurations and may enable load balancing algorithms that distribute computational workloads based on system capacity and operational requirements. In some cases, a dual-configuration architecture may provide fault tolerance capabilities where the second processing configuration may assume operational responsibilities if components in the first processing configuration experience failures or maintenance requirements.

The output processing module 612 may coordinate with both processing configurations to implement compactness properties where ciphertext length may be bounded by m·B(λ) regardless of circuit complexity. The output processing module 612 may utilize the computational capabilities of both the processing device 802 and the processing device 804 to perform padding operations that ensure consistent output formatting across different. operational scenarios. In some cases, the output processing module 612 may pad the homomorphically evaluated ciphertext to a target length \hat{m}(λ) by appending zero bits through coordinated operations between the two processing configurations.

The comprehensive input/output capabilities of the computer system 800 may enable flexible interaction modalities that support different user requirements and operational environments. The combination of the alphanumeric input device 814, the cursor control device 816, the user input/output interfaces 812, and the user input/output interfaces 812 may provide multiple pathways for user interaction with the cryptographic hash system. The video display unit 810, the video processing unit 826, and the video processing unit. 826 may coordinate to provide comprehensive visual output capabilities that support complex cryptographic system monitoring and management operations.

The storage systems within the computer system 800 may provide distributed storage capabilities that enhance system reliability and performance. The coordination between the data storage device 820 and the data storage device 820 may enable redundant storage of cryptographic data and may provide enhanced access performance through parallel storage operations. The static memory 806 and the static memory 808 may maintain synchronized copies of system configurations and may ensure system consistency across both processing configurations during operational transitions or maintenance procedures.

### Client Architecture

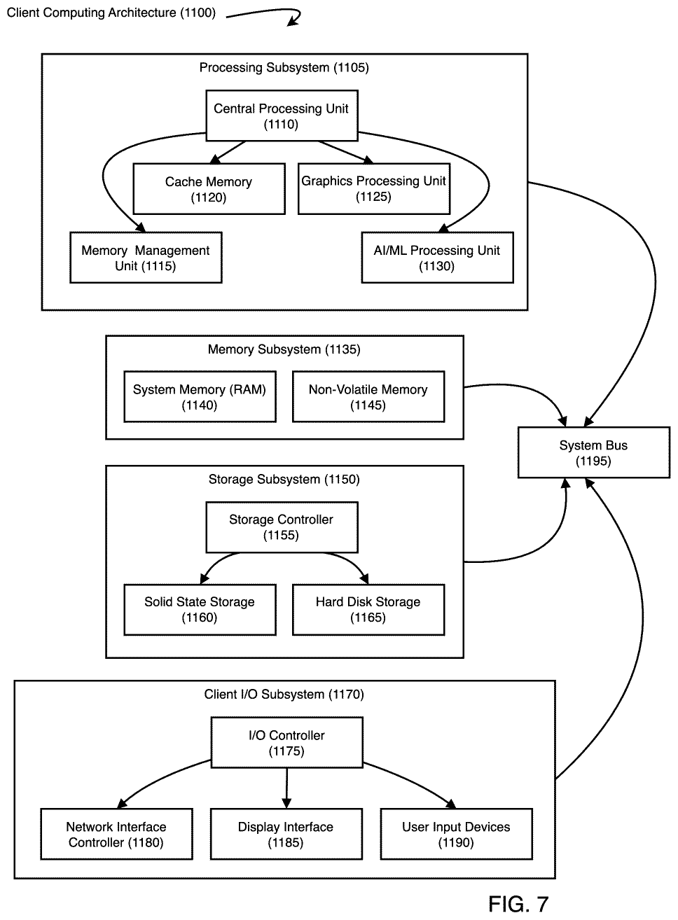

FIG. 7 illustrates a Client Computing Architecture 1100 that provides a comprehensive computing framework for implementing cryptographic hash function operations through specialized subsystems that coordinate to deliver enhanced computational capabilities. The Client Computing Architecture 1100 may enable the execution of complex homomorphic encryption operations and hash computations through modular components that work together to process cryptographic data while maintaining security properties and computational efficiency.

The Client Computing Architecture 1100 includes a Processing Subsystem 1105 that serves as the computational foundation for executing cryptographic algorithms and managing data processing operations throughout the system. The Processing Subsystem 1105 may coordinate with other subsystems within the Client Computing Architecture 1100 to provide comprehensive computational capabilities that support the execution of the method 100 and related cryptographic operations. In some cases, the Processing Subsystem 1105 may implement specialized processing algorithms optimized for homomorphic encryption schemes and may provide computational resources that enable the efficient execution of boolean circuit evaluations and hash function computations.

The Processing Subsystem 1105 contains a Central Processing Unit 1110 that serves as the primary computational component for executing instructions and performing data processing operations within the Client Computing Architecture 1100. The Central Processing Unit 1110 may execute the core logic for cryptographic hash function operations including the generation of secret keys sk as described in the step 106, the construction of boolean circuits Cₓ as implemented in the step 114, and the coordination of homomorphic evaluation operations as performed in the step 116. In some cases, the Central Processing Unit 1110 may implement instruction sets optimized for cryptographic computations and may provide computational capabilities that support the mathematical operations associated with fully homomorphic encryption schemes based on Learning With Errors assumptions or other lattice-based cryptographic constructions.

A Memory Management Unit 1115 within the Processing Subsystem 1105 handles memory allocation and virtual memory operations that enable efficient utilization of memory resources during cryptographic computations. The Memory Management Unit 1115 may manage the allocation of memory space for storing intermediate computational results generated during homomorphic evaluation processes and may coordinate memory access operations between the Central Processing Unit 1110 and memory subsystems. In some cases, the Memory Management Unit 1115 may implement memory protection mechanisms that prevent unauthorized access to cryptographic data stored in memory and may provide virtual memory capabilities that enable the processing of large datasets that exceed physical memory limitations.

The Processing Subsystem 1105 incorporates a Cache Memory 1120 that provides high-speed temporary storage for frequently accessed data and instructions during cryptographic operations. The Cache Memory 1120 may store copies of cryptographic algorithms, hash function implementations, and frequently used data structures to reduce memory access latency during computational operations. In some cases, the Cache Memory 1120 may implement specialized caching algorithms optimized for cryptographic workloads and may provide multiple cache levels that balance access speed with storage capacity to optimize the performance of homomorphic evaluation operations and hash computations.

A Graphics Processing Unit 1125 within the Processing Subsystem 1105 processes graphics rendering and parallel computing tasks that may accelerate cryptographic computations through specialized hardware architectures. The Graphics Processing Unit 1125 may perform multiple homomorphic evaluation operations simultaneously and may provide computational acceleration for the boolean circuit evaluations described in the step 116. In some cases, the Graphics Processing Unit 1125 may coordinate with the homomorphic evaluation module 610 to perform parallel processing of cryptographic operations and may utilize specialized algorithms optimized for parallel execution architectures that enable efficient processing of large-scale hash computations.

The Processing Subsystem 1105 includes an AI/ML Processing Unit 1130 that handles artificial intelligence and machine learning computations that may enhance cryptographic operations through intelligent optimization and adaptive algorithms. The AI/ML Processing Unit 1130 may implement machine learning algorithms that optimize the performance of cryptographic computations and may provide intelligent resource allocation capabilities that adapt to varying computational workloads. In some cases, the AI/ML Processing Unit 1130 may coordinate with the parameter input module 602 to optimize system parameters based on operational patterns and may implement adaptive algorithms that enhance the efficiency of homomorphic encryption operations through intelligent computational scheduling.

The Client Computing Architecture 1100 incorporates a Memory Subsystem 1135 that provides comprehensive memory capabilities for storing data and programs during cryptographic operations. The Memory Subsystem 1135 may coordinate with the Processing Subsystem 1105 to provide high-speed access to cryptographic data and may implement memory hierarchies that optimize data access patterns for hash function computations. In some cases, the Memory Subsystem 1135 may provide specialized memory capabilities that support the storage requirements of fully homomorphic encryption schemes and may implement memory protection mechanisms that maintain the confidentiality of cryptographic data during processing operations.

The Memory Subsystem 1135 comprises a System Memory (RAM) 1140 that provides volatile storage for active programs and data during system operation. The System Memory (RAM) 1140 may store intermediate computational results generated during the execution of the method 100 and may maintain working copies of ciphertext data during hash computation operations. In some cases, the System Memory (RAM) 1140 may provide high-bandwidth access to cryptographic data structures and may enable efficient data transfer between the Processing Subsystem 1105 and other components within the Client Computing Architecture 1100 during complex mathematical operations associated with homomorphic evaluation processes.

A Non-Volatile Memory 1145 within the Memory Subsystem 1135 offers persistent storage that retains data when power may be removed from the Client Computing Architecture 1100. The Non-Volatile Memory 1145 may store cryptographic algorithms, hash function implementations, and system configurations that define the operational characteristics of the keyed hash function system 600. In some cases, the Non-Volatile Memory 1145 may maintain security parameters including the integer parameters n and m received in the step 102 and the circuit-size parameter S received in the step 104, providing persistent storage for configuration data that guides the behavior of cryptographic operations across power cycles.

The Client Computing Architecture 1100 includes a Storage Subsystem 1150 that provides comprehensive storage capabilities for long-term data retention and system file management. The Storage Subsystem 1150 may coordinate with the hash key storage 614 to provide secure storage for cryptographic keys and computed hash values, implementing specialized security features that protect stored cryptographic data from unauthorized access or tampering. In some cases, the Storage Subsystem 1150 may provide distributed storage capabilities that enhance system reliability and may implement backup and recovery mechanisms that ensure data availability during system maintenance or failure scenarios.

The Storage Subsystem 1150 includes a Storage Controller 1155 that manages data transfer operations between storage devices and other system components within the Client Computing Architecture 1100. The Storage Controller 1155 may coordinate data transfer operations for storing the ciphertext ct generated in the step 108 and may manage access to stored hash function outputs generated in the step 120. In some cases, the Storage Controller 1155 may implement specialized protocols optimized for cryptographic data transfer and may provide access control mechanisms that restrict storage operations to authorized system components while maintaining the integrity of stored cryptographic data.

A Solid State Storage 1160 within the Storage Subsystem 1150 provides fast, non-volatile storage using flash memory technology that enables rapid access to cryptographic data and system files. The Solid State Storage 1160 may store frequently accessed cryptographic algorithms and may provide high-speed storage for intermediate computational results that require persistent storage during complex hash computations. In some cases, the Solid State Storage 1160 may implement wear leveling algorithms that optimize storage performance for cryptographic workloads and may provide enhanced reliability features that protect against data corruption during intensive computational operations.

The Storage Subsystem 1150 incorporates a Hard Disk Storage 1165 that offers high-capacity magnetic storage for long-term data retention and archival purposes. The Hard Disk Storage 1165 may store historical records of hash computations and may provide backup storage for cryptographic keys and system configurations. In some cases, the Hard Disk Storage 1165 may implement specialized security features including encryption at rest and may provide large-capacity storage capabilities that support the retention of extensive cryptographic datasets and computational logs for audit and compliance purposes.

The Client Computing Architecture 1100 includes a Client I/O Subsystem 1170 that provides comprehensive input and output capabilities for user interaction and external system communication. The Client I/O Subsystem 1170 may coordinate with the message input handler 616 to receive input messages for hash computation and may facilitate the output of hash function results generated by the output processing module 612. In some cases, the Client I/O Subsystem 1170 may implement specialized protocols for secure data transfer and may provide multiple interaction modalities that support different user requirements and operational environments.

The Client I/O Subsystem 1170 contains an I/O Controller 1175 that manages input and output operations between the Client Computing Architecture 1100 and external devices or systems. The I/O Controller 1175 may coordinate the reception of input messages x as described in the step 112 and may manage the output of hash function results generated in the step 120. In some cases, the I/O Controller 1175 may implement specialized protocols for secure data transfer and may provide access control mechanisms that verify the authorization of external systems attempting to access cryptographic services provided by the Client Computing Architecture 1100.

A Network Interface Controller 1180 within the Client I/O Subsystem 1170 enables network communication capabilities that facilitate data exchange with external systems and distributed computing environments. The Network Interface Controller 1180 may support secure communication protocols that protect the confidentiality and integrity of cryptographic data transmitted to and from the Client Computing Architecture 1100. In some cases, the Network Interface Controller 1180 may enable distributed hash function operations where multiple Client Computing Architecture 1100 instances collaborate to perform cryptographic computations and may provide network capabilities that support. the transmission of hash results to remote verification systems.

The Client I/O Subsystem 1170 incorporates a Display Interface 1185 that handles video output to display devices and provides visual representation capabilities for cryptographic operations. The Display Interface 1185 may generate graphical representations of hash computation progress and may display hash function outputs in various formats for user verification and analysis. In some cases, the Display Interface 1185 may coordinate with the output processing module 612 to display formatted hash results and may provide real-time visualization of computational progress during the execution of complex homomorphic evaluation operations described in the step 116.

User Input Devices 1190 within the Client I/O Subsystem 1170 provide user interaction capabilities with the Client Computing Architecture 1100 that enable data input and system control operations. The User Input Devices 1190 may enable users to provide input messages for hash computation and may facilitate the configuration of system parameters that define hash function behavior. In some cases, the User Input Devices 1190 may coordinate with the parameter input module 602 to receive configuration parameters and may provide mechanisms for users to monitor and control the execution of cryptographic operations throughout the method 100.

A System Bus 1195 connects all subsystems within the Client Computing Architecture 1100, facilitating data transfer and communication between the Processing Subsystem 1105, the Memory Subsystem 1135, the Storage Subsystem 1150, and the Client. I/O Subsystem 1170. The System Bus 1195 may enable high-speed data transfer protocols that minimize latency during cryptographic operations and may provide sufficient. bandwidth to support the data-intensive operations associated with homomorphic encryption and hash computation. In some cases, the System Bus 1195 may implement. specialized protocols optimized for cryptographic data transfer and may provide quality of service mechanisms that prioritize critical computational operations during complex hash function evaluations.

The System Bus 1195 may coordinate the transfer of secret keys sk from the Processing Subsystem 1105 to the Memory Subsystem 1135 during the execution of the step 106 and may facilitate the movement of ciphertext ct from the Processing Subsystem 1105 to the Storage Subsystem 1150 during the step 110. The System Bus 1195 may enable the transfer of input messages x from the Client I/O Subsystem 1170 to the Processing Subsystem 1105 during the step 112 and may coordinate the output of hash function results from the Processing Subsystem 1105 to the Client I/O Subsystem 1170 during the step 120. In some cases, the System Bus 1195 may provide the interconnection infrastructure that enables the coordinated operation of all subsystems during the execution of cryptographic hash function operations while maintaining the security and integrity of data transfer operations.

The hierarchical organization of the Memory Subsystem 1135 and the Storage Subsystem 1150 may provide optimized data access patterns that enhance the performance of cryptographic computations. The Cache Memory 1120 within the Processing Subsystem 1105 may coordinate with the System Memory (RAM) 1140 to provide multi-level memory hierarchies that minimize access latency for frequently used cryptographic data. The Storage Controller 1155 may coordinate access between the Solid State Storage 1160 and the Hard Disk Storage 1165 to provide tiered storage capabilities that balance access speed with storage capacity based on the access patterns of cryptographic data and computational results.

The specialized processing capabilities within the Processing Subsystem 1105 may enable parallel execution of cryptographic operations that enhance the computational efficiency of hash function evaluations. The Central Processing Unit 1110 may coordinate with the Graphics Processing Unit 1125 to distribute computational workloads between general-purpose and specialized processing units, enabling efficient execution of the boolean circuit evaluations described in the step 116. The AI/ML Processing Unit 1130 may provide intelligent optimization capabilities that adapt computational strategies based on operational patterns and may implement machine learning algorithms that enhance the efficiency of homomorphic encryption operations through predictive resource allocation and adaptive algorithm selection.

The comprehensive I/O capabilities provided by the Client I/O Subsystem 1170 may enable flexible interaction modalities that support different user requirements and operational environments. The I/O Controller 1175 may coordinate with the Network Interface Controller 1180 to provide both local and remote access capabilities for cryptographic services, enabling the Client Computing Architecture 1100 to operate in distributed computing environments while maintaining security boundaries. The Display Interface 1185 may coordinate with the User Input Devices 1190 to provide interactive interfaces that enable users to monitor and control cryptographic operations while maintaining appropriate access controls and security measures.

The modular architecture of the Client Computing Architecture 1100 may enable independent optimization and configuration of each subsystem while maintaining proper coordination through the System Bus 1195. The Processing Subsystem 1105 may provide computational foundation services that support the operations of the Memory Subsystem 1135, the Storage Subsystem 1150, and the Client I/O Subsystem 1170. The Memory Subsystem 1135 may provide data storage and access capabilities that enable efficient execution of cryptographic algorithms, while the Storage Subsystem 1150 may provide persistent storage capabilities that maintain cryptographic data and system configurations across operational cycles. The Client I/O Subsystem 1170 may provide external interface capabilities that enable integration with broader cryptographic infrastructures while maintaining the security boundaries established by the other subsystems within the Client Computing Architecture 1100.

### Network Infrastructure

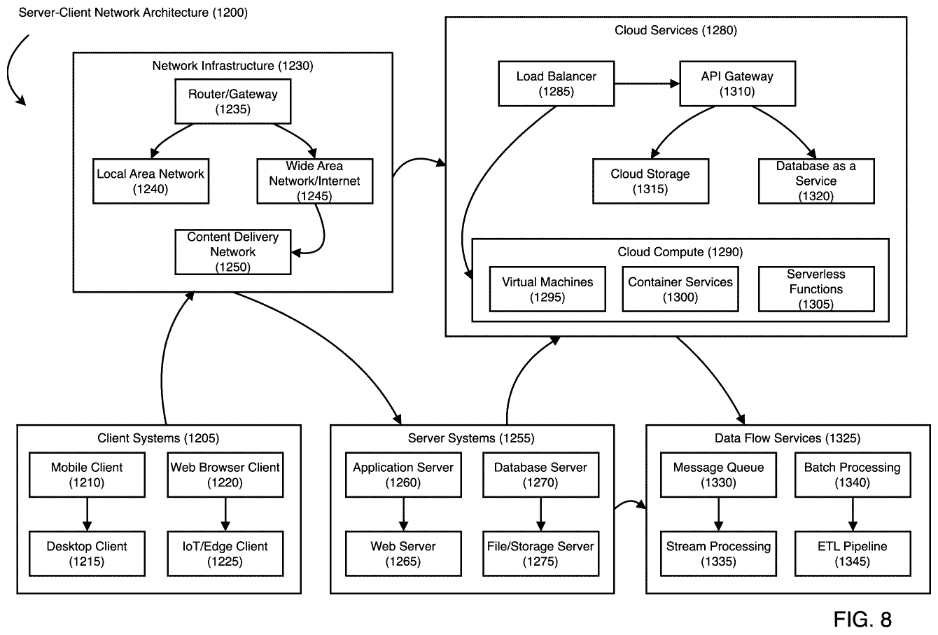

FIG. 8 illustrates a Server-Client Network Architecture 1200 that provides a comprehensive distributed computing ecosystem for implementing scalable cryptographic hash operations across multiple interconnected components and service layers. The Server-Client Network Architecture 1200 may enable the deployment of the keyed hash function system 600 and the cryptographic hash system 702 across distributed computing environments while maintaining security properties and computational efficiency through coordinated operation of client systems, network infrastructure, server systems, cloud services, and data flow services.

The Server-Client Network Architecture 1200 includes Client Systems 1205 that provide diverse access points for users and applications to interact with the distributed cryptographic hash services. The Client Systems 1205 may enable the execution of hash function operations across different device types and computing platforms while maintaining consistent security properties and operational capabilities. In some cases, the Client Systems 1205 may coordinate with the parameter input module 602 to receive configuration parameters for hash function operations and may utilize the message input handler 616 to provide input messages for distributed hash computation across the network infrastructure.

The Client Systems 1205 comprise four distinct client types that provide specialized access capabilities for different operational scenarios and user requirements. A Mobile Client 1210 provides mobile device access to the distributed cryptographic hash services, enabling users to perform hash computations and verification operations through smart-phones, tablets, and other portable computing devices. The Mobile Client 1210 may implement lightweight versions of the cryptographic hash system 702 that optimize computational efficiency for resource-constrained environments while maintaining security properties. In some cases, the Mobile Client 1210 may coordinate with the API 736 to access remote hash computation services and may utilize the user interface 738 to provide mobile-optimized interaction capabilities for cryptographic operations.

A Desktop Client 1215 within the Client Systems 1205 offers traditional desktop computer connectivity that enables comprehensive access to distributed cryptographic hash services through full-featured computing environments. The Desktop Client 1215 may implement complete versions of the keyed hash function system 600 and may provide enhanced computational capabilities for complex hash operations including homomorphic evaluation processes. In some cases, the Desktop Client 1215 may coordinate with the graphics processing unit 514 to accelerate cryptographic computations and may utilize the data storage device 512 to maintain local copies of hash keys and computational results for offline operation capabilities.

The Client Systems 1205 incorporate a Web Browser Client 1220 that enables web-based access to cryptographic hash services through standard web browsers without requiring specialized software installations. The Web Browser Client 1220 may implement JavaScript-based versions of hash function algorithms and may provide cross-platform compatibility for accessing distributed cryptographic services. In some cases, the Web Browser Client 1220 may coordinate with the interface module 734 to provide web-based user interfaces for hash computation operations and may utilize secure communication protocols to protect cryptographic data during transmission between the browser and server systems.

An IoT/Edge Client 1225 within the Client Systems 1205 facilitates Internet of Things and edge device integration that enables cryptographic hash operations in distributed sensor networks and edge computing environments. The IoT/Edge Client 1225 may implement specialized versions of hash function algorithms optimized for low-power and resource-constrained devices while maintaining security properties. In some cases, the IoT/Edge Client 1225 may coordinate with the message processing module 712 to handle sensor data and telemetry information that requires hash-based integrity verification and may utilize the authentication module 728 to provide device authentication capabilities in distributed IoT deployments.

The Server-Client Network Architecture 1200 incorporates a Network Infrastructure 1230 that forms the communication backbone enabling data transfer and coordination between client systems, server systems, and cloud services. The Network Infrastructure 1230 may provide the connectivity foundation that enables distributed execution of the method 100 across multiple computing nodes while maintaining security properties and data integrity. In some cases, the Network Infrastructure 1230 may implement specialized protocols optimized for cryptographic data transfer and may provide quality of service mechanisms that prioritize hash computation operations based on security requirements and computational urgency.

The Network Infrastructure 1230 includes a Router/Gateway 1235 that manages network traffic routing and gateway functions between different network segments within the distributed computing environment. The Router/Gateway 1235 may coordinate data flow between the Client Systems 1205 and server systems while implementing security policies that protect cryptographic data during transmission. In some cases, the Router/Gateway 1235 may coordinate with the network interface device 508 to provide secure communication channels and may implement access control mechanisms that verify the authorization of client systems attempting to access distributed cryptographic services.

A Local Area Network 1240 within the Network Infrastructure 1230 provides localized network connectivity for nearby devices and systems that participate in distributed hash computation operations. The Local Area Network 1240 may enable high-speed communication between client systems and local server resources while minimizing latency for time-sensitive cryptographic operations. In some cases, the Local Area Network 1240 may coordinate with the communication bus 520 to provide network-based extensions of system interconnectivity and may implement specialized protocols that optimize data transfer for cryptographic workloads within localized computing environments.

The Network Infrastructure 1230 incorporates a Wide Area Network/Internet 1245 that enables broad geographic connectivity and internet access for distributed cryptographic hash operations across global computing infrastructures. The Wide Area Network/Internet 1245 may provide the connectivity foundation that enables collaboration between geographically distributed computing resources while maintaining security properties through encrypted communication channels. In some cases, the Wide Area Network/Internet 1245 may coordinate with the Network Interface Controller 1180 to provide internet connectivity capabilities and may implement routing protocols that optimize data paths for cryptographic data transmission across long-distance network connections.

A Content Delivery Network 1250 within the Network Infrastructure 1230 optimizes content distribution and delivery performance across the distributed computing environment by providing geographically distributed caching and content acceleration capabilities. The Content Delivery Network 1250 may cache frequently accessed cryptographic algorithms and hash function implementations to reduce latency for client systems accessing distributed services. In some cases, the Content Delivery Network 1250 may coordinate with the static memory 506 to provide distributed storage of cryptographic libraries and may implement caching strategies that optimize the delivery of hash computation results to client systems based on geographic proximity and network performance characteristics.

The Server-Client Network Architecture 1200 includes Server Systems 1255 that provide centralized computing resources and services for executing complex cryptographic hash operations that exceed the computational capabilities of individual client systems. The Server Systems 1255 may implement high-performance versions of the keyed hash function system 600 and may provide computational resources that enable the execution of complex homomorphic evaluation operations described in the step 116. In some cases, the Server Systems 1255 may coordinate with the Processing Subsystem 1105 to provide distributed processing capabilities and may utilize specialized hardware configurations that optimize performance for cryptographic computations.

The Server Systems 1255 contain multiple server components that provide specialized services for different aspects of distributed cryptographic hash operations. An Application Server 1260 hosts and executes application logic and business processes that coordinate cryptographic hash operations across the distributed computing environment. The Application Server 1260 may implement the core logic for the method 100 and may coordinate the execution of hash function operations across multiple computing nodes. In some cases, the Application Server 1260 may coordinate with the homomorphic evaluation module 610 to distribute complex computational operations and may implement load balancing algorithms that optimize resource utilization across available computing resources.

A Web Server 1265 within the Server Systems 1255 handles web-based requests and serves web content that enables client systems to access cryptographic hash services through standard web protocols. The Web Server 1265 may provide web-based interfaces for the user interface 738 and may implement secure communication protocols that protect cryptographic data during web-based interactions. In some cases, the Web Server 1265 may coordinate with the Web Browser Client 1220 to provide browser-based access to hash computation services and may implement authentication mechanisms that verify the identity of users accessing distributed cryptographic services through web interfaces.

The Server Systems 1255 incorporate a Database Server 1270 that manages data storage and retrieval operations for cryptographic keys, hash computation results, and system configuration data. The Database Server 1270 may coordinate with the hash key storage 614 to provide distributed storage capabilities for cryptographic keys and may implement database security features that protect stored cryptographic data from unauthorized access. In some cases, the Database Server 1270 may coordinate with the key storage 708 to provide centralized key management capabilities and may implement. backup and recovery mechanisms that ensure data availability during system maintenance or failure scenarios.

A File/Storage Server 1275 within the Server Systems 1255 provides file storage and management capabilities for large-scale cryptographic datasets and computational results. The File/Storage Server 1275 may coordinate with the data storage device 512 to provide distributed storage capabilities and may implement specialized storage protocols optimized for cryptographic data. In some cases, the File/Storage Server 1275 may coordinate with the Storage Subsystem 1150 to provide tiered storage capabilities that balance access speed with storage capacity based on the access patterns of cryptographic data and computational results.

The Server-Client Network Architecture 1200 incorporates Cloud Services 1280 that encompass cloud-based computing resources and services that provide scalable infrastructure for distributed cryptographic hash operations. The Cloud Services 1280 may enable elastic scaling of computational resources based on demand and may provide geographic distribution capabilities that optimize performance for global user bases. In some cases, the Cloud Services 1280 may coordinate with the Client Computing Architecture 1100 to provide cloud-based extensions of local computing capabilities and may implement service-level agreements that guarantee performance and availability characteristics for cryptographic operations.

The Cloud Services 1280 include a Load Balancer 1285 that distributes incoming requests across multiple servers to optimize performance and ensure high availability of cryptographic hash services. The Load Balancer 1285 may implement algorithms that. distribute computational workloads based on server capacity and current utilization levels while maintaining session affinity for stateful cryptographic operations. In some cases, the Load Balancer 1285 may coordinate with the processing device 502 to monitor computational loads and may implement failover mechanisms that redirect traffic to healthy servers during component failures or maintenance operations.

An API Gateway 1310 within the Cloud Services 1280 manages application programming interface access and routing for distributed cryptographic services, providing a unified entry point for client systems to access various hash computation capabilities. The API Gateway 1310 may coordinate with the API 736 to provide standardized interfaces for cryptographic operations and may implement authentication and authorization mechanisms that control access to distributed services. In some cases, the API Gateway 1310 may implement rate limiting and throttling mechanisms that prevent abuse of cryptographic services and may provide API versioning capabilities that enable backward compatibility during system updates and enhancements.

The Cloud Services 1280 incorporate Cloud Storage 1315 that provides scalable cloud-based storage solutions for cryptographic keys, hash computation results, and system data. The Cloud Storage 1315 may coordinate with the Storage Controller 1155 to provide distributed storage capabilities that span multiple geographic regions while maintaining data consistency and availability. In some cases, the Cloud Storage 1315 may implement encryption at rest and in transit to protect stored cryptographic data and may provide backup and disaster recovery capabilities that ensure data durability across multiple availability zones.

A Database as a Service 1320 within the Cloud Services 1280 offers managed database services in the cloud environment that provide scalable and reliable data storage for cryptographic applications. The Database as a Service 1320 may coordinate with the Database Server 1270 to provide cloud-based database capabilities and may implement automated backup, scaling, and maintenance operations that reduce operational overhead. In some cases, the Database as a Service 1320 may provide specialized database configurations optimized for cryptographic workloads and may implement security features including encryption, access controls, and audit logging that protect sensitive cryptographic data.

The Cloud Services 1280 include Cloud Compute 1290 that provides virtualized computing resources for executing distributed cryptographic hash operations across scalable infrastructure. The Cloud Compute 1290 may enable the deployment of the keyed hash function system 600 across multiple virtual computing instances while maintaining performance and security characteristics. In some cases, the Cloud Compute 1290 may coordinate with the Central Processing Unit 1110 to provide distributed processing capabilities and may implement auto-scaling mechanisms that adjust computational resources based on demand patterns for cryptographic operations.

The Cloud Compute 1290 encompasses three computing service models that provide different approaches to deploying and executing cryptographic applications. Virtual Machines 1295 provide virtualized computing resources that enable the deployment of complete operating system environments for executing cryptographic hash applications. The Virtual Machines 1295 may provide isolated execution environments for the cryptographic hash system 702 and may implement security features including virtual machine isolation and encrypted storage that protect cryptographic operations from interference or unauthorized access. In some cases, the Virtual Machines 1295 may coordinate with the Memory Subsystem 1135 to provide virtualized memory capabilities and may implement live migration capabilities that enable workload mobility across different physical computing resources.

Container Services 1300 within the Cloud Compute 1290 offer containerized application deployment and management that enables lightweight and portable deployment of cryptographic hash applications across different computing environments. The Container Services 1300 may provide container orchestration capabilities that manage the deployment and scaling of cryptographic applications while maintaining security boundaries between different application instances. In some cases, the Container Services 1300 may coordinate with the AI/ML Processing Unit 1130 to provide intelligent container scheduling and may implement security features including container isolation and image scanning that protect against vulnerabilities in containerized cryptographic applications.

The Cloud Compute 1290 incorporates Serverless Functions 1305 that enable event-driven, serverless computing capabilities for executing specific cryptographic operations without managing underlying infrastructure. The Serverless Functions 1305 may provide on-demand execution of hash computation operations and may implement automatic scaling that adjusts computational resources based on incoming requests. In some cases, the Serverless Functions 1305 may coordinate with the output processing module 612 to provide serverless hash computation capabilities and may implement event-driven architectures that trigger hash operations based on data availability or external system events.

The Server-Client Network Architecture 1200 includes Data Flow Services 1325 that manage data processing and movement throughout the distributed computing system, providing specialized capabilities for handling the data-intensive operations associated with cryptographic hash computations. The Data Flow Services 1325 may coordinate with the message processing module 712 to provide distributed data processing capabilities and may implement data pipeline architectures that optimize the flow of cryptographic data through different processing stages. In some cases, the Data Flow Services 1325 may provide data transformation and routing capabilities that enable the integration of cryptographic hash operations with broader data processing workflows.

The Data Flow Services 1325 incorporate a Message Queue 1330 that handles asynchronous message passing between system components, enabling decoupled communication patterns that improve system resilience and scalability. The Message Queue 1330 may coordinate with the message input handler 616 to provide queuing capabilities for input messages awaiting hash computation and may implement message persistence and delivery guarantees that ensure reliable processing of cryptographic operations. In some cases, the Message Queue 1330 may provide message routing capabilities that direct different types of cryptographic operations to appropriate processing resources and may implement priority queuing mechanisms that prioritize time-sensitive hash computations.

A Stream Processing 1335 component within the Data Flow Services 1325 processes continuous data streams in real-time, enabling the processing of high-volume data flows that require immediate hash computation and verification. The Stream Processing 1335 may coordinate with the homomorphic evaluation module 610 to provide real-time processing of encrypted data streams and may implement windowing and aggregation operations that optimize the processing of continuous cryptographic workloads. In some cases, the Stream Processing 1335 may provide complex event processing capabilities that detect patterns in cryptographic data streams and may implement low-latency processing architectures that minimize the delay between data arrival and hash computation completion.

The Data Flow Services 1325 include Batch Processing 1340 that manages large-scale data processing jobs for handling bulk cryptographic operations that process large datasets in scheduled or triggered batch operations. The Batch Processing 1340 may coordinate with the boolean circuit construction module 608 to provide batch processing of multiple hash computations and may implement job scheduling and resource allocation mechanisms that optimize the utilization of computational resources for large-scale cryptographic workloads. In some cases, the Batch Processing 1340 may provide fault. tolerance capabilities that enable the recovery and resumption of interrupted batch operations and may implement data partitioning strategies that enable parallel processing of large cryptographic datasets across multiple computing nodes.

An ETL Pipeline 1345 within the Data Flow Services 1325 performs extract, transform, and load operations for data integration that enable the preprocessing and formatting of data for cryptographic hash operations. The ETL Pipeline 1345 may coordinate with the padding 714 and the segmentation 716 to provide data transformation capabilities that prepare input data for hash computation operations. In some cases, the ETL Pipeline 1345 may implement data validation and cleansing operations that ensure data quality before cryptographic processing and may provide data lineage tracking capabilities that maintain audit trails for cryptographic operations performed on processed datasets.

The interconnected pathways within the Server-Client Network Architecture 1200 enable comprehensive data flow between the Client Systems 1205, the Network Infrastructure 1230, the Server Systems 1255, the Cloud Services 1280, and the Data Flow Services 1325. The data flow pathways may enable the distributed execution of the method 100 across multiple computing nodes while maintaining security properties and computational efficiency. In some cases, the interconnected pathways may implement secure communication protocols that protect cryptographic data during transmission and may provide load balancing capabilities that distribute computational workloads across available resources based on capacity and performance characteristics.

The Network Infrastructure 1230 may coordinate with the I/O Controller 1175 to provide network connectivity capabilities that enable client systems to access distributed cryptographic services while maintaining security boundaries and access controls. The Router/Gateway 1235 may implement routing protocols that optimize data paths for cryptographic data transmission and may provide network security features including firewalls and intrusion detection systems that protect against network-based attacks on cryptographic infrastructure.

The integration between the Server Systems 1255 and the Cloud Services 1280 may provide hybrid deployment capabilities that combine on-premises computing resources with cloud-based services to optimize performance, cost, and security characteristics for different cryptographic applications. The Application Server 1260 may coordinate with the Virtual Machines 1295 to provide scalable execution environments for cryptographic applications, while the Database Server 1270 may coordinate with the Database as a Service 1320 to provide hybrid data storage capabilities that balance performance requirements with cost considerations.

The Data Flow Services 1325 may provide the data processing infrastructure that enables the Server-Client Network Architecture 1200 to handle the data-intensive operations associated with cryptographic hash computations while maintaining performance and scalability characteristics. The Message Queue 1330 may coordinate with the authentication module 728 to provide secure message handling capabilities, while the Stream Processing 1335 may coordinate with the HMAC computation module 718 to provide real-time hash computation capabilities for streaming data applications.

The comprehensive architecture of the Server-Client Network Architecture 1200 may enable the deployment of cryptographic hash services across diverse computing environments while maintaining consistent security properties and operational capabilities. The modular design of the architecture may enable independent scaling and optimization of different components based on specific performance requirements and operational constraints, while the interconnected pathways may provide the communication infrastructure that enables coordinated operation across the distributed computing ecosystem.

Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multi-core and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage (NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and non-volatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for high-dimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A method for generating and evaluating a keyed hash function, the method comprising:
a. electronically receiving one or more integer parameters indicating a target message input length n and a target hash output length m for a keyed hash function;
b. electronically receiving a target circuit-size parameter S, wherein the circuit-size parameter S is correlated to a security level of the keyed hash function;
c. generating a hash key, the generated hash key comprising a ciphertext ct of a secret-key fully homomorphic encryption (FHE) scheme, wherein the ciphertext ct is generated by:
i. generating a secret key sk for the secret-key FHE scheme;
ii. generating the ciphertext ct as an encryption to sk of an internal message μ, the internal message μ comprising sk concatenated with a string of S zero bits;
iii. storing the ciphertext ct as the generated hash key;
d. electronically receiving an input message x having length of n bits, wherein x is padded to length n if of length less than n;
e. computing a hash output based on the generated hash key ct and the input message x, by:
i. generating an encryption ŷ by:
a. constructing a representation Cₓ of a boolean circuit that on input of a pair (sk, E), wherein E is a representation of a boolean circuit, Cₓ computes an output by:
i. evaluating E on input message x to obtain a list of length [symbol] (ŷ₁, . . . , [symbol] );
ii. executing an FHE decryption procedure of the FHE scheme on each ŷᵢ, using secret key sk, to generate a corresponding m-bit string yᵢ for (ŷ₁, . . . , [symbol] );
iii. storing as the output the lexicographically first m-bit string that is not one of y₁, . . . , [symbol] ;
b. homomorphically evaluating Cₓ on the hash key ct and storing the result as encryption ŷ; and
ii. appending zero bits to the homomorphically evaluated ciphertext ŷ such that it has length m, and storing the result as the output of the keyed hash function.

2. The method of claim 1, wherein S is selected such that a larger value of S corresponds to a hash function whose mapping of inputs to outputs is relatively more pseudorandom, and wherein the circuit-size parameter S specifies a level of circuit complexity such that the constructed keyed hash function should satisfy somewhere-statistical correlation intractability with respect to all relations whose circuit complexity is at most S.

3. The method of claim 1, wherein the keyed hash function is utilized in a secure computing application involving indistinguishability obfuscation to obfuscate a program, such that the program remains functionally identical to the original but is hard to understand or reverse-engineer, and wherein the keyed hash function is employed in a secure multi-party computation protocol to ensure that each party's input remains private while allowing the computation of a joint function.

4. The method of claim 1, wherein the keyed hash function is used in a digital rights management system to obfuscate the process of license verification and content authentication, and wherein the keyed hash function is applied in a public-key encryption scheme to enhance the security of the encryption by obfuscating the relationship between the public and private keys.

5. The method of claim 1, wherein the keyed hash function is used to generate obfuscated cryptographic keys in a Key Derivation Function, thereby securing the process of deriving keys from a master secret.

6. The method of claim 1, wherein the keyed hash function is integrated into a software distribution system to obfuscate the hashing of code segments for integrity verification.

7. The method of claim 1, wherein the keyed hash function is utilized in a privacy-preserving data processing application to obfuscate the transformation of sensitive data while maintaining data integrity.

8. An apparatus for generating and evaluating a keyed hash function, the apparatus comprising:
a. one or more processors;
b. a memory communicatively coupled to the one or more processors, the memory storing instructions that, when executed by the one or more processors, cause the apparatus to:
i. electronically receive one or more integer parameters indicating a target message input length n and a target hash output length m for a keyed hash function;
ii. electronically receive a target circuit-size parameter S, wherein the circuit-size parameter S is correlated to a security level of the keyed hash function;
iii. generate a hash key, the generated hashkey comprising a ciphertext ct of a secret-key fully homomorphic encryption (FHE) scheme, wherein the ciphertext ct is generated by:
a. generating a secret-key sk for the secret-key FHE scheme;
b. generating the ciphertext ct as an encryption to sk of an internal message μ, the internal message μ comprising sk concatenated with a string of S zero bits;
c. storing the ciphertext ct as the generated hashkey;
iv. electronically receive an input message x having a length of n bits, wherein x is padded to length n if of length less than n;
v. compute a hash output based on the generated hashkey ct and the input message x, by:
i. generating an encryption ŷ by:
a. constructing a representation Cₓ of a boolean circuit that on input of a pair (sk, E), wherein E is a representation of a boolean circuit, Cₓ computes an output by:
b. evaluating E on input message x to obtain a list of length [symbol] (ŷ₁, . . . , [symbol] );
c. executing an FHE decryption procedure of the FHE scheme on each ŷᵢ, using secret-key sk, to generate a corresponding m-bit string yᵢ for (y₁, . . . , [symbol] );
d. storing as the output the lexicographically first m-bit string that is not one of y₁, . . . , [symbol] ;
e. homomorphically evaluating Cₓ on the hashkey ct and storing the result as encryption ŷ; and
ii. appending zero bits to the homomorphically evaluated ciphertext ŷ such that it has length m, and storing the result as the output of the keyed hash function.

9. The apparatus of claim 8, wherein S is selected such that a larger value of S corresponds to a hash function whose mapping of inputs to outputs is relatively more pseudo-random, and wherein the circuit-size parameter S specifies a level of circuit complexity such that the constructed keyed hash function satisfies somewhere-statistical correlation intractability with respect to all relations whose circuit complexity is at most S.

10. The apparatus of claim 8, wherein the keyed hash function is utilized in a secure computing application involving indistinguishability obfuscation to obfuscate a program, such that the program remains functionally identical to the original but is hard to understand or reverse-engineer, and wherein the keyed hash function is employed in a secure multi-party computation protocol to ensure that each party's input remains private while allowing the computation of a joint function.

11. The apparatus of claim 8, wherein the keyed hash function is used in a digital rights management system to obfuscate the process of license verification and content authentication, and wherein the keyed hash function is applied in a public-key encryption scheme to enhance the security of the encryption by obfuscating the relationship between the public and private keys.

12. The apparatus of claim 8, wherein the keyed hash function is used to generate obfuscated cryptographic keys in a Key Derivation Function, thereby securing the process of deriving keys from a master secret.

13. The apparatus of claim 8, wherein the keyed hash function is integrated into a software distribution system to obfuscate the hashing of code segments for integrity verification.

14. The apparatus of claim 8, wherein the keyed hash function is utilized in a privacy-preserving data processing application to obfuscate the transformation of sensitive data while maintaining data integrity.

15. A non-transitory computer-readable medium storing instructions that, when executed by one or more processors of a computer system, cause the computer system to perform a method for generating and evaluating a keyed hash function, the method comprising:
a. electronically receiving one or more integer parameters indicating a target message input length n and a target hash output length m for a keyed hash function;
b. electronically receiving a target circuit-size parameter S, wherein the circuit-size parameter S is correlated to a security level of the keyed hash function;
c. generating a hashkey, the generated hashkey comprising a ciphertext ct of a secret-key fully homomorphic encryption (FHE) scheme, wherein the ciphertext ct is generated by:
i. generating a secret-key sk for the secret-key FHE scheme;
ii. generating the ciphertext ct as an encryption to sk of an internal message μ, the internal message μ comprising sk concatenated with a string of S zero bits;
iii. storing the ciphertext ct as the generated hashkey;
d. electronically receiving an input message x having a length of n bits, wherein x is padded to length n if of length less than n;
e. computing a hash output based on the generated hashkey ct and the input message x, by:
i. generating an encryption ŷ by:
a. constructing a representation Cₓ of a boolean circuit that on input of a pair (sk, E), wherein E is a representation of a boolean circuit, Cₓ computes an output by:
i. evaluating E on input message a to obtain a list of length [symbol] (ŷ₁, . . . , [symbol] );
ii. executing an FHE decryption procedure of the FHE scheme on each ŷᵢ, using secret-key sk, to generate a corresponding m-bit string yᵢ for (y₁, . . . , [symbol] );
iii. storing as the output the lexicographically first m-bit string that is not one of y₁, . . . , [symbol] ;
b. homomorphically evaluating Cₓ on the hashkey ct and storing the result as encryption ŷ; and
ii. appending zero bits to the homomorphically evaluated ciphertext ŷ such that it has length m, and storing the result as the output of the keyed hash function.

16. The non-transitory computer-readable medium of claim 15, wherein S is selected such that a larger value of S corresponds to a hash function whose mapping of inputs to outputs is relatively more pseudorandom, and wherein the circuit-size parameter S specifies a level of circuit complexity such that the constructed keyed hash function satisfies somewhere-statistical correlation intractability with respect to all relations whose circuit complexity is at least S.

17. The non-transitory computer-readable medium of claim 15, wherein the keyed hash function is utilized in a secure computing application involving indistinguishability obfuscation to obfuscate a program, such that the program remains functionally identical to the original but is hard to understand or reverse-engineer, and wherein the keyed hash function is employed in a secure multi-party computation protocol to ensure that each party's input remains private while allowing the computation of a joint function.

18. The non-transitory computer-readable medium of claim 15, wherein the keyed hash function is used in a digital rights management system to obfuscate the process of license verification and content authentication, and wherein the keyed hash function is applied in a public-key encryption scheme to enhance the security of the encryption by obfuscating the relationship between the public and private keys.

19. The non-transitory computer-readable medium of claim 15, wherein the keyed hash function is used to generate obfuscated cryptographic keys in a Key Derivation Function, thereby securing the process of deriving keys from a master secret, and wherein the keyed hash function is integrated into a software distribution system to obfuscate the hashing of code segments for integrity verification.

20. The non-transitory computer-readable medium of claim 15, wherein the keyed hash function is utilized in a privacy-preserving data processing application to obfuscate the transformation of sensitive data while maintaining data integrity.
